(19) United States
(12) Patent Application Publication
(10) Pub. No.: US 2024/0340145 A1
(43) Pub. Date: Oct. 10, 2024

(54) PRIORITIZATION OF POSITIONING REFERENCE SIGNAL PROCESSING FOR SOUNDING REFERENCE SIGNALS FOR POSITIONING

(71) Applicant: QUALCOMM Incorporated, San Diego, CA (US)

(72) Inventors: Alexandros MANOLAKOS, Athens (GR); Mukesh KUMAR, Hyderabad (IN); Srinivas YERRAMALLI, San Diego, CA (US)

(21) Appl. No.: 18/580,975

(22) PCT Filed: Jun. 2, 2022
(86) PCT No.: PCT/US2022/072728

§ 371 Date: Jan. 19, 2024

(30) Foreign Application Priority Data
Jul. 21, 2021 (GR) 20210100494

(51) Int. Cl. H04L 5/00; H04W 64/00

(52) U.S. Cl. CPC H04L 5/0053; H04L 5/005; H04W 64/00

(57) ABSTRACT

Disclosed are techniques for wireless communication. In an aspect, a user equipment (UE) may receive first information identifying a plurality of positioning reference signal (PRS) resources. The UE may receive second information identifying a plurality of PRS measurement occasions in a time domain. The UE may receive third information identifying a plurality of sounding reference signals (SRSs) and their respective transmission occasions in the time domain. The UE may receive fourth information identifying, for each of the plurality of SRSs, one or more PRS resources as reference signals for the respective SRS. The UE may process PRS resources according to a prioritization scheme such that PRS resources that are reference signals for the respective SRS are prioritized over PRS resources that are not reference signals for the respective SRS.

### CROSS-REFERENCE TO RELATED APPLICATIONS

The present Application for Patent claims the benefit of GR application Ser. No. 20210100494, entitled “PRIORITIZATION OF POSITIONING REFERENCE SIGNAL PROCESSING FOR SOUNDING REFERENCE SIGNALS FOR POSITIONING”, filed Jul. 21, 2021, and is a national stage application, filed under 35 U.S.C. § 371, of International Patent Application No. PCT/US2022/072728, entitled, “PRIORITIZATION OF POSITIONING REFERENCE SIGNAL PROCESSING FOR SOUNDING REFERENCE SIGNALS FOR POSITIONING”, filed Jun. 2, 2022, both of which are assigned to the assignee hereof and are expressly incorporated herein by reference in their entirety.

### BACKGROUND OF THE DISCLOSURE

### 1. Field of the Disclosure

Aspects of the disclosure relate generally to wireless communications.

### 2. Description of the Related Art

Wireless communication systems have developed through various generations, including a first-generation analog wireless phone service (1G), a second-generation (2G) digital wireless phone service (including interim 2.5G and 2.75G networks), a third-generation (3G) high speed data, Internet-capable wireless service and a fourth-generation (4G) service (e.g., Long Term Evolution (LTE) or WiMax). There are presently many different types of wireless communication systems in use, including cellular and personal communications service (PCS) systems. Examples of known cellular systems include the cellular analog advanced mobile phone system (AMPS), and digital cellular systems based on code division multiple access (CDMA), frequency division multiple access (FDMA), time division multiple access (TDMA), the Global System for Mobile communications (GSM), etc.

A fifth generation (5G) wireless standard, referred to as New Radio (NR), calls for higher data transfer speeds, greater numbers of connections, and better coverage, among other improvements. The 5G standard, according to the Next Generation Mobile Networks Alliance, is designed to provide data rates of several tens of megabits per second to each of tens of thousands of users, with 1 gigabit per second to tens of workers on an office floor. Several hundreds of thousands of simultaneous connections should be supported in order to support large sensor deployments. Consequently, the spectral efficiency of 5G mobile communications should be significantly enhanced compared to the current 4G standard. Furthermore, signaling efficiencies should be enhanced and latency should be substantially reduced compared to current standards.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In an aspect, a method of wireless communication performed by a user equipment (UE) includes receiving first information identifying a plurality of positioning reference signal (PRS) resources; receiving second information identifying a plurality of PRS measurement occasions in a time domain; receiving third information identifying a plurality of sounding reference signals (SRSs) and their respective transmission occasions in the time domain; receiving fourth information identifying, for each of the plurality of SRSs, one or more PRS resources as reference signals for the respective SRS; and processing PRS resources according to a prioritization scheme such that PRS resources that are reference signals for the respective SRS are prioritized over PRS resources that are not reference signals for the respective SRS.

In an aspect, a user equipment (UE) includes a memory; at least one transceiver; and at least one processor communicatively coupled to the memory and the at least one transceiver, the at least one processor configured to; receive, via the at least one transceiver, first information identifying a plurality of positioning reference signal (PRS) resources; receive, via the at least one transceiver, second information identifying a plurality of PRS measurement occasions in a time domain; receive, via the at least one transceiver, third information identifying a plurality of sounding reference signals (SRSs) and their respective transmission occasions in the time domain; receive, via the at least one transceiver, fourth information identifying, for each of the plurality of SRSs, one or more PRS resources as reference signals for the respective SRS; and process PRS resources according to a prioritization scheme such that PRS resources that are reference signals for the respective SRS are prioritized over PRS resources that are not reference signals for the respective SRS.

In an aspect, a user equipment (UE) includes means for receiving first information identifying a plurality of positioning reference signal (PRS) resources; means for receiving second information identifying a plurality of PRS measurement occasions in a time domain; means for receiving third information identifying a plurality of sounding reference signals (SRSs) and their respective transmission occasions in the time domain; means for receiving fourth information identifying, for each of the plurality of SRSs, one or more PRS resources as reference signals for the respective SRS; and means for processing PRS resources according to a prioritization scheme such that PRS resources that are reference signals for the respective SRS are prioritized over PRS resources that are not reference signals for the respective SRS.

In an aspect, a non-transitory computer-readable medium storing computer-executable instructions that, when executed by a user equipment (UE), cause the UE to: receive first information identifying a plurality of positioning reference signal (PRS) resources; receive second information identifying a plurality of PRS measurement occasions in a time domain; receive third information identifying a plurality of sounding reference signals (SRSs) and their respective transmission occasions in the time domain; receive fourth information identifying, for each of the plurality of SRSs, one or more PRS resources as reference signals for the respective SRS; and process PRS resources according to a prioritization scheme such that PRS resources that are reference signals for the respective SRS are prioritized over PRS resources that are not reference signals for the respective SRS.

Other objects and advantages associated with the aspects disclosed herein will be apparent to those skilled in the art based on the accompanying drawings and detailed description.

### BRIEF DESCRIPTION OF THE DRAWINGS

The accompanying drawings are presented to aid in the description of various aspects of the disclosure and are provided solely for illustration of the aspects and not limitation thereof.

FIG. 1 illustrates an example wireless communications system, according to aspects of the disclosure.

FIGS. 2A and 2B illustrate example wireless network structures. according to aspects of the disclosure.

FIGS. 3A, 3B, and 3C are simplified block diagrams of several sample aspects of components that may be employed in a user equipment (UE), a base station, and a network entity, respectively, and configured to support communications as taught herein.

FIGS. 4A and 4B are diagrams illustrating example frame structures and channels within the frame structures, according to aspects of the disclosure.

FIG. 5 is a signaling message and event diagram illustrating conventional prioritization of UL and DL positioning resources.

FIG. 6 shows an example scenario in which PRS occasions have a different period than SRS occasions.

FIGS. 7A and 7B illustrate examples of bow conventional PRS prioritization can produce sub-optimal results.

FIG. 8 illustrates a method for prioritization of PRS processing for SRSs for positioning according to some aspects of the disclosure.

FIG. 9 illustrates a method for prioritization of PRS processing for SRSs for positioning according to some aspects of the disclosure.

FIG. 10 illustrates a method of prioritization of PRS resources processing based on spatial relations to the SRS signals which use those PRS resources for beam references according to some aspects of the disclosure.

FIG. 11 is a flowchart of an example process associated with prioritization of PRS processing for SRS for positioning.

### DETAILED DESCRIPTION

Aspects of the disclosure are provided in the following description and related drawings directed to various examples provided for illustration purposes. Alternate aspects may be devised without departing from the scope of the disclosure. Additionally, well-known elements of the disclosure will not be described in detail or will be omitted so as not to obscure the relevant details of the disclosure.

The words “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage, or mode of operation.

Those of skill in the art will appreciate that the information and signals described below may be represented using any of a variety of different technologies and techniques. For example, data, instructions, commands, information, signals, bits, symbols, and chips that may be referenced throughout the description below may be represented by voltages, currents, electromagnetic waves, magnetic fields or particles, optical fields or particles, or any combination thereof, depending in part on the particular application, in part on the desired design, in part on the corresponding technology, etc.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, the sequence(s) of actions described herein can be considered to be embodied entirely within any form of non-transitory computer-readable storage medium having stored therein a corresponding set of computer instructions that, upon execution, would cause or instruct an associated processor of a device to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

As used herein, the terms “user equipment” (UE) and “base station” are not intended to be specific or otherwise limited to any particular radio access technology (RAT), unless otherwise noted. In general, a UE may be any wireless communication device (e.g., a mobile phone, router, tablet computer, laptop computer, consumer asset locating device, wearable (e.g., smartwatch, glasses, augmented reality (AR)/virtual reality (VR) headset, etc.), vehicle (e.g., automobile, motorcycle, bicycle, etc.), Internet of Things (IoT) device, etc.) used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or “UT,” a “mobile device,” a “mobile terminal,” a “mobile station,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on the Institute of Electrical and Electronics Engineers (IEEE) 802.11 specification, etc.) and so on.

A base station may operate according to one of several RATs in communication with UEs depending on the network in which it is deployed, and may be alternatively referred to as an access point (AP), a network node, a NodeB, an evolved NodeB (eNB), a next generation eNB (ng-eNB), a New Radio (NR) Node B (also referred to as a gNB or gNodeB), etc. A base station may be used primarily to support wireless access by UEs, including supporting data, voice, and/or signaling connections for the supported UEs. In some systems a base station may provide purely edge node signaling functions while in other systems it may provide additional control and/or network management functions. A communication link through which UEs can send signals to a base station is called an uplink (UL) channel (e.g., a reverse traffic channel, a reverse control channel, an access channel, etc.). A communication link through which the base station can send signals to UEs is called a downlink (DL) or forward link channel (e.g., a paging channel, a control channel, a broadcast channel, a forward traffic channel, etc.). As used herein the term traffic channel (TCH) can refer to either an uplink/reverse or downlink/forward traffic channel.

The term “base station” may refer to a single physical transmission-reception point (TRP) or to multiple physical TRPs that may or may not be co-located. For example, where the term “base station” refers to a single physical TRP, the physical TRP may be an antenna of the base station corresponding to a cell (or several cell sectors) of the base station. Where the term “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (a network of spatially separated antennas connected to a common source via a transport medium) or a remote radio head (RRH) (a remote base station connected to a serving base station). Alternatively, the non-co-located physical TRPs may be the serving base station receiving the measurement report from the UE and a neighbor base station whose reference radio frequency (RF) signals the UE is measuring. Because a TRP is the point from which a base station transmits and receives wireless signals, as used herein, references to transmission from or reception at a base station are to be understood as referring to a particular TRP of the base station.

In some implementations that support positioning of UEs, a base station may not support wireless access by UEs (e.g., may not support data, voice, and/or signaling connections for UEs), but may instead transmit reference signals to UEs to be measured by the UEs, and/or may receive and measure signals transmitted by the UEs. Such a base station may be referred to as a positioning beacon (e.g., when transmitting signals to UEs) and/or as a location measurement unit (e.g., when receiving and measuring signals from UEs).

An “RF signal” comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

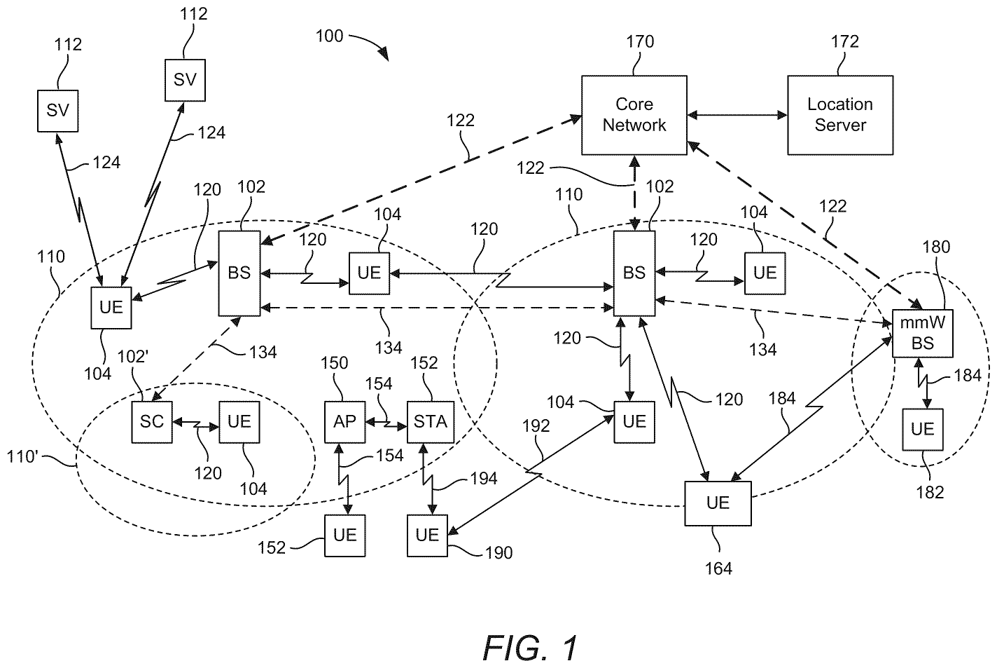

FIG. 1 illustrates an example wireless communications system 100. according to aspects of the disclosure. The wireless communications system 10, (which may also be referred to as a wireless wide area network (WWAN)) may include various base stations 102 (labeled “BS”) and various UEs 104. The base stations 102 may include macro cell base stations (high power cellular base stations) and/or small cell base stations (low power cellular base stations). In an aspect, the macro cell base stations may include eNBs and/or ng-eNBs where the wireless communications system 100 corresponds to an LTE network, or gNBs where the wireless communications system 100 corresponds to a NR network, or a combination of both, and the small cell base stations may include femtocells, picocells, microcells, etc.

The base stations 102 may collectively form a RAN and interface with a core network 170 (e.g., an evolved packet core (EPC) or a 5G core (5GC)) through backhaul links 122, and through the core network 170 to one or more location servers 172 (e.g., a location management function (LMF) or a secure user plane location (SUPL) location platform (SLP)). The location server(s) 172 may be part of core network 170 or may be external to core network 170. In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace. RAN information management (RIM), paging, positioning, and delivery of warning messages. The base stations 102 may communicate with each other directly or indirectly (e.g., through the EPC/5GC) over backhaul links 134, which may be wired or wireless.

The base stations 102 may wirelessly communicate with the UEs 104. Each of the base stations 102 may provide communication coverage for a respective geographic coverage area 110. In an aspect, one or more cells may be supported by a base station 102 in each geographic coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), an enhanced cell identifier (ECI), a virtual cell identifier (VCI), a cell global identifier (CGI), etc.) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of UEs. Because a cell is supported by a specific base station, the term “cell” may refer to either or both of the logical communication entity and the base station that supports it, depending on the context. In addition, because a TRP is typically the physical transmission point of a cell, the terms “cell” and “TRP” may be used interchangeably. In some cases, the term “cell” may also refer to a geographic coverage area of a base station (e.g., a sector), insofar as a carrier frequency can be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ (labeled “SC” for “small cell”) may have a geographic coverage area 110′ that substantially overlaps with the geographic coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include uplink (also referred to as reverse link) transmissions from a UE 104 to a base station 102 and/or downlink (DL) (also referred to as forward link) transmissions from a base station 102 to a UE 104. The communication links 120 may use MIMO antenna technology, including spatial multiplexing, beamforming, and/or transmit diversity. The communication links 120 may be through one or more carrier frequencies. Allocation of carriers may be asymmetric with respect to downlink and uplink (e.g., more or less carriers may be allocated for downlink than for uplink).

The wireless communications system 100 may further include a wireless local area network (WLAN) access point (AP) 150 in communication with WLAN stations (STAs) 152 via communication links 154 in an unlicensed frequency spectrum (e.g., 5 GHz). When communicating in an unlicensed frequency spectrum, the WLAN STAs 152 and/or the WLAN AP 150 may perform a clear channel assessment (CCA) or listen before talk (LBT) procedure prior to communicating in order to determine whether the channel is available.

The small cell base station 102′ may operate in a licensed and/or an unlicensed frequency spectrum. When operating in an unlicensed frequency spectrum, the small cell base station 102′ may employ LTE or NR technology and use the same 5 GHz unlicensed frequency spectrum as used by the WLAN AP 150. The small cell base station 102′, employing LTE/5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MulteFire.

The wireless communications system 100 may further include a millimeter wave (mmW) base station 180 that may operate in mmW frequencies and/or near mmW frequencies in communication with a UE 182. Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band have high path loss and a relatively short range. The mmW base station 180 and the UE 182 may utilize beamforming (transmit and/or receive) over a mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

Transmit beamforming is a technique for focusing an RF signal in a specific direction. Traditionally, when a network node (e.g., a base station) broadcasts an RF signal, it broadcasts the signal in all directions (omni-directionally). With transmit beamforming, the network node determines where a given target device (e.g., a UE) is located (relative to the transmitting network node) and projects a stronger downlink RF signal in that specific direction, thereby providing a faster (in terms of data rate) and stronger RF signal for the receiving device(s). To change the directionality of the RF signal when transmitting, a network node can control the phase and relative amplitude of the RF signal at each of the one or more transmitters that are broadcasting the RF signal. For example, a network node may use an array of antennas (referred to as a “phased array” or an “antenna array”) that creates a beam of RF waves that can be “steered” to point in different directions, without actually moving the antennas. Specifically, the RF current from the transmitter is fed to the individual antennas with the correct phase relationship so that the radio waves from the separate antennas add together to increase the radiation in a desired direction, while cancelling to suppress radiation in undesired directions.

Transmit beams may be quasi-co-located, meaning that they appear to the receiver (e.g., a UE) as having the same parameters, regardless of whether or not the transmitting antennas of the network node themselves are physically co-located. In NR, there are four types of quasi-co-location (QCL) relations. Specifically, a QCL relation of a given type means that certain parameters about a second reference RF signal on a second beam can be derived from information about a source reference RF signal on a source beam. Thus, if the source reference RF signal is QCL Type A, the receiver can use the source reference RF signal to estimate the Doppler shift, Doppler spread, average delay, and delay spread of a second reference RF signal transmitted on the same channel. If the source reference RF signal is QCL Type B, the receiver can use the source reference RF signal to estimate the Doppler shift and Doppler spread of a second reference RF signal transmitted on the same channel. If the source reference RF signal is QCL Type C, the receiver can use the source reference RF signal to estimate the Doppler shift and average delay of a second reference RF signal transmitted on the same channel. If the source reference RF signal is QCL Type D, the receiver can use the source reference RF signal to estimate the spatial receive parameter of a second reference RF signal transmitted on the same channel.

In receive beamforming, the receiver uses a receive beam to amplify RF signals detected on a given channel. For example, the receiver can increase the gain setting and/or adjust the phase setting of an array of antennas in a particular direction to amplify (e.g., to increase the gain level of) the RF signals received from that direction. Thus, when a receiver is said to beamform in a certain direction, it means the beam gain in that direction is high relative to the beam gain along other directions, or the beam gain in that direction is the highest compared to the beam gain in that direction of all other receive beams available to the receiver. This results in a stronger received signal strength (e.g., reference signal received power (RSRP), reference signal received quality (RSRQ), signal-to-interference-plus-noise ratio (SINR), etc.) of the RF signals received from that direction.

Transmit and receive beams may be spatially related. A spatial relation means that parameters for a second beam (e.g., a transmit or receive beam) for a second reference signal can be derived from information about a first beam (e.g., a receive beam or a transmit beam) for a first reference signal. For example, a UE may use a particular receive beam to receive a reference downlink reference signal (e.g., synchronization signal block (SSB)) from a base station. The UE can then form a transmit beam for sending an uplink reference signal (e.g., sounding reference signal (SRS)) to that base station based on the parameters of the receive beam.

Note that a “downlink” beam may be either a transmit beam or a receive beam, depending on the entity forming it. For example, if a base station is forming the downlink beam to transmit a reference signal to a UE, the downlink beam is a transmit beam. If the UE is forming the downlink beam, however, it is a receive beam to receive the downlink reference signal. Similarly, an “uplink” beam may be either a transmit beam or a receive beam, depending on the entity forming it. For example, if a base station is forming the uplink beam, it is an uplink receive beam, and if a UE is forming the uplink beam, it is an uplink transmit beam.

In 5G, the frequency spectrum in which wireless nodes (e.g., base stations 102/180, UEs 104/182) operate is divided into multiple frequency ranges, FR1 (from 450 to 6000 MHz), FR2 (from 24250 to 52600 MHz), FR3 (above 52600 MHz), and FR4 (between FR1 and FR2), mmW frequency bands generally include the FR2, FR3, and FR4 frequency ranges. As such, the terms “mmW” and “FR2” or “FR3” or “FR4” may generally be used interchangeably.

In a multi-carrier system, such as 5G, one of the carrier frequencies is referred to as the “primary carrier” or “anchor carrier” or “primary serving cell” or “PCell.” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels, and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (whether a PCell or an SCell) corresponds to a carrier frequency/component carrier over which some base station is communicating, the term “cell,” “serving cell,” “component carrier,” “carrier frequency,” and the like can be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (i.e., 40 MHz), compared to that attained by a single 20 MHz carrier.

The wireless communications system 100 may further include a UE 164 that may communicate with a macro cell base station 102 over a communication link 120 and/or the mmW base station 180 over a mmW communication link 184. For example, the macro cell base station 102 may support a PCell and one or more SCells for the UE 164 and the mmW base station 180 may support one or more SCells for the UE 164.

In the example of FIG. 1, any of the illustrated UEs (shown in FIG. 1 as a single UE 104 for simplicity) may receive signals 124 from one or more Earth orbiting space vehicles (SVs) 112 (e.g., satellites). In an aspect, the SVs 112 may be part of a satellite positioning system that a UE 104 can use as an independent source of location information. A satellite positioning system typically includes a system of transmitters (e.g., SVs 112) positioned to enable receivers (e.g., UEs 104) to determine their location on or above the Earth based, at least in part, on positioning signals (e.g., signals 124) received from the transmitters. Such a transmitter typically transmits a signal marked with a repeating pseudo-random noise (PN) code of a set number of chips. While typically located in SVs 112, transmitters may sometimes be located on ground-based control stations, base stations 102, and/or other UEs 104. A UE 104 may include one or more dedicated receivers specifically designed to receive signals 124 for deriving geo location information from the SVs 112.

In a satellite positioning system, the use of signals 124 can be augmented by various satellite-based augmentation systems (SBAS) that may be associated with or otherwise enabled for use with one or more global and/or regional navigation satellite systems. For example an SBAS may include an augmentation system(s) that provides integrity information, differential corrections, etc., such as the Wide Area Augmentation System (WAAS), the European Geostationary Navigation Overlay Service (EGNOS), the Multi-functional Satellite Augmentation System (MSAS), the Global Positioning System (GPS) Aided Geo Augmented Navigation or GPS and Geo Augmented Navigation system (GAGAN), and/or the like. Thus, as used herein, a satellite positioning system may include any combination of one or more global and/or regional navigation satellites associated with such one or more satellite positioning systems.

In an aspect, SVs 112 may additionally or alternatively be part of one or more non-terrestrial networks (NTNs). In an NTN, an SV 112 is connected to an earth station (also referred to as a ground station, NTN gateway, or gateway), which in turn is connected to an element in a 5G network, such as a modified base station 102 (without a terrestrial antenna) or a network node in a 5GC. This element would in turn provide access to other elements in the SG network and ultimately to entities external to the 5G network, such as Internet web servers and other user devices. In that way, a UE 104 may receive communication signals (e.g., signals 124) from an SV 112 instead of, or in addition to, communication signals from a terrestrial base station 102.

The wireless communications system 100 may further include one or more UEs, such as UE 190, that connects indirectly to one or more communication networks via one or more device-to-device (D2D) peer-to-peer (P2P) links (referred to as “sidelinks”). In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (through which UE 190 may indirectly obtain WLAN-based Internet connectivity). In an example, the D2D P2P links 192 and 194 may be supported with any well-known D2D RAT, such as LTE Direct (LTE-D), WiFi Direct (WiFi-D), Bluetooth®, and so on.

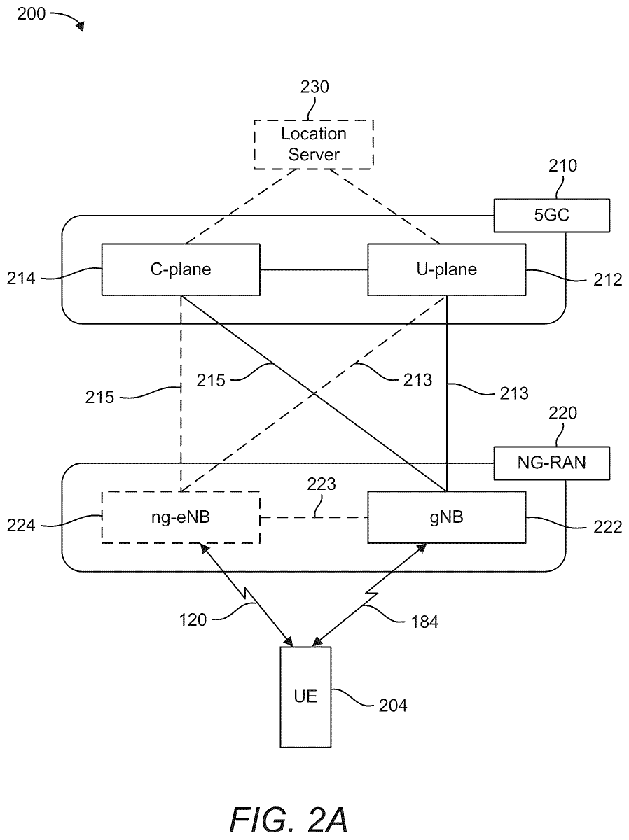

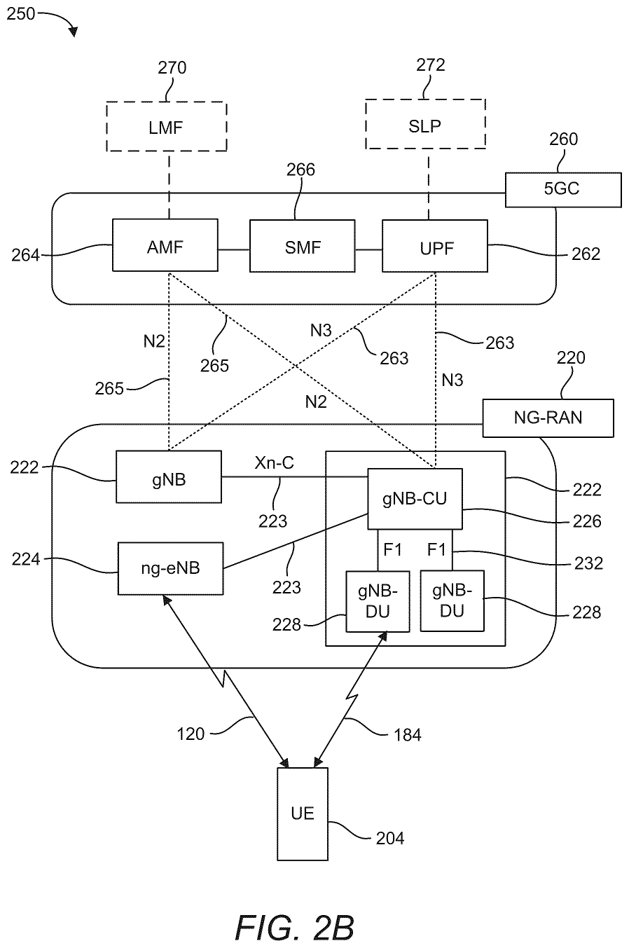

FIG. 2A illustrates an example wireless network structure 200. For example, a 5GC 210 (also referred to as a Next Generation Core (NGC)) can be viewed functionally as control plane (C-plane) functions 214 (e.g., UE registration, authentication, network access, gateway selection, etc.) and user plane (U-plane) functions 212, (e.g., UE gateway function, access to data networks, IP routing, etc.) which operate cooperatively to form the core network. User plane interface (NG-U) 213 and control plane interface (NG-C) 215 connect the gNB 222 to the 5GC 210 and specifically to the user plane functions 212 and control plane functions 214, respectively. In an additional configuration, an ng-eNB 224 may also be connected to the 5GC 210 via NG-C 215 to the control plane functions 214 and NG-U 213 to user plane functions 212. Further, ng-eNB 224 may directly communicate with gNB 222 via a backhaul connection 223. In some configurations, a Next Generation RAN (NG-RAN) 220 may have one or more gNBs 222, while other configurations include one or more of both ng-eNBs 224 and gNBs 222. Either (or both) gNB 222 or ng-eNB 224 may communicate with one or more UEs 204 (e.g., any of the UEs described herein).

Another optional aspect may include a location server 230, which may be in communication with the 5GC 210 to provide location assistance for UE(s) 204. The location server 230 can be implemented as a plurality of separate servers (e.g., physically separate servers, different software modules on a single server, different software modules spread across multiple physical servers, etc.), or alternately may each correspond to a single server. The location server 230 can be configured to support one or more location services for UEs 204 that can connect to the location server 230 via the core network, 5GC 210, and/or via the Internet (not illustrated). Further, the location server 230 may be integrated into a component of the core network, or alternatively may be external to the core network (e.g., a third-party server, such as an original equipment manufacturer (OEM) server or service server).

FIG. 2B illustrates another example wireless network structure 250. A 5GC 260 (which may correspond to 5GC 210 in FIG. 2A) can be viewed functionally as control plane functions, provided by an access and mobility management function (AMF) 264, and user plane functions, provided by a user plane function (UPF) 262, which operate cooperatively to form the core network (i.e., 5GC 260). The functions of the AMF 264 include registration management. connection management, reachability management, mobility management, lawful interception, transport for session management (SM) messages between one or more UEs 204 (e.g., any of the UEs described herein) and a session management function (SMF) 266, transparent proxy services for routing SM messages, access authentication and access authorization, transport for short message service (SMS) messages between the UE 204 and the short message service function (SMSF) (not shown), and security anchor functionality (SEAF). The AMF 264 also interacts with an authentication server function (AUSF) (not shown) and the UE 204, and receives the intermediate key that was established as a result of the UE 204 authentication process. In the case of authentication based on a UMTS (universal mobile telecommunications system) subscriber identity module (USIM), the AMF 264 retrieves the security material from the AUSF. The functions of the AMF 264 also include security context management (SCM). The SCM receives a key from the SEAF that it uses to derive access-network specific keys. The functionality of the AMF 264 also includes location services management for regulatory services, transport for location services messages between the UE 204 and a location management function (LMF) 270 (which acts as a location server 230), transport for location services messages between the NG-RAN 220 and the LMF 270. evolved packet system (EPS) bearer identifier allocation for interworking with the EPS, and UE 204 mobility event notification. In addition, the AMF 264 also supports functionalities for non-3GPP (Third Generation Partnership Project) access networks.

Functions of the UPF 262 include acting as an anchor point for intra-/inter-RAT mobility (when applicable), acting as an external protocol data unit (PDU) session point of interconnect to a data network (not shown), providing packet routing and forwarding, packet inspection, user plane policy rule enforcement (e.g., gating, redirection, traffic steering), lawful interception (user plane collection), traffic usage reporting, quality of service (QOS) handling for the user plane (e.g., uplink/downlink rate enforcement, reflective QoS marking in the downlink), uplink traffic verification (service data flow (SDF) to QoS flow mapping), transport level packet marking in the uplink and downlink, downlink packet buffering and downlink data notification triggering, and sending and forwarding of one or more “end markers” to the source RAN node. The UPF 262 may also support transfer of location services messages over a user plane between the UE 204 and a location server, such as an SLP 272.

The functions of the SMF 266 include session management, UE Internet protocol (IP) address allocation and management, selection and control of user plane functions, configuration of traffic steering at the UPF 262 to route traffic to the proper destination, control of part of policy enforcement and QoS, and downlink data notification. The interface over which the SMF 266 communicates with the AMF 264 is referred to as the N11 interface.

Another optional aspect may include an LMF 270, which may be in communication with the 5GC 260 to provide location assistance for UEs 204. The LMF 270 can be implemented as a plurality of separate servers (e.g., physically separate servers, different software modules on a single server, different software modules spread across multiple physical servers, etc.), or alternately may each correspond to a single server. The LMF 270 can be configured to support one or more location services for UEs 204 that can connect to the LMF 270 via the core network, 5GC 260, and/or via the Internet (not illustrated). The SLP 272 may support similar functions to the LMF 270, but whereas the LMF 270 may communicate with the AMF 264, NG-RAN 220, and UEs 204 over a control plane (e.g., using interfaces and protocols intended to convey signaling messages and not voice or data), the SLP 272 may communicate with UEs 204 and external clients (not shown in FIG. 2B) over a user plane (e.g., using protocols intended to carry voice and/or data like the transmission control protocol (TCP) and/or IP).

User plane interface 263 and control plane interface 265 connect the 5GC 260, and specifically the UPF 262 and AMF 264, respectively, to one or more gNBs 222 and/or ng-eNBs 224 in the NG-RAN 220. The interface between gNB(s) 222 and/or ng-eNB(s) 224 and the AMF 264 is referred to as the “N2” interface, and the interface between gNB(s) 222 and/or ng-eNB(s) 224 and the UPF 262 is referred to as the “N3” interface. The gNB(s) 222 and/or ng-eNB(s) 224 of the NG-RAN 220 may communicate directly with each other via backhaul connections 223, referred to as the “Xn-C” interface. One or more of gNBs 222 and/or ng-eNBs 224 may communicate with one or more UEs 204 over a wireless interface, referred to as the “Uu” interface.

The functionality of a gNB 222 is divided between a gNB central unit (gNB-CU) 226 and one or more gNB distributed units (gNB-DUs) 228. The interface 232 between the gNB-CU 226 and the one or more gNB-DUs 228 is referred to as the “F1” interface. A gNB-CU 226 is a logical node that includes the base station functions of transferring user data, mobility control, radio access network sharing, positioning, session management, and the like, except for those functions allocated exclusively to the gNB-DU(s) 228. More specifically, the gNB-CU 226 hosts the radio resource control (RRC), service data adaptation protocol (SDAP), and packet data convergence protocol (PDCP) protocols of the gNB 222. A gNB-DU 228 is a logical node that hosts the radio link control (RLC), medium access control (MAC), and physical (PHY) layers of the gNB 222. Its operation is controlled by the gNB-CU 226. One gNB-DU 228 can support one or more cells, and one cell is supported by only one gNB-DU 228. Thus, a UE 204 communicates with the gNB-CU 226 via the RRC, SDAP, and PDCP layers and with a gNB-DU 228 via the RLC, MAC, and PHY layers.

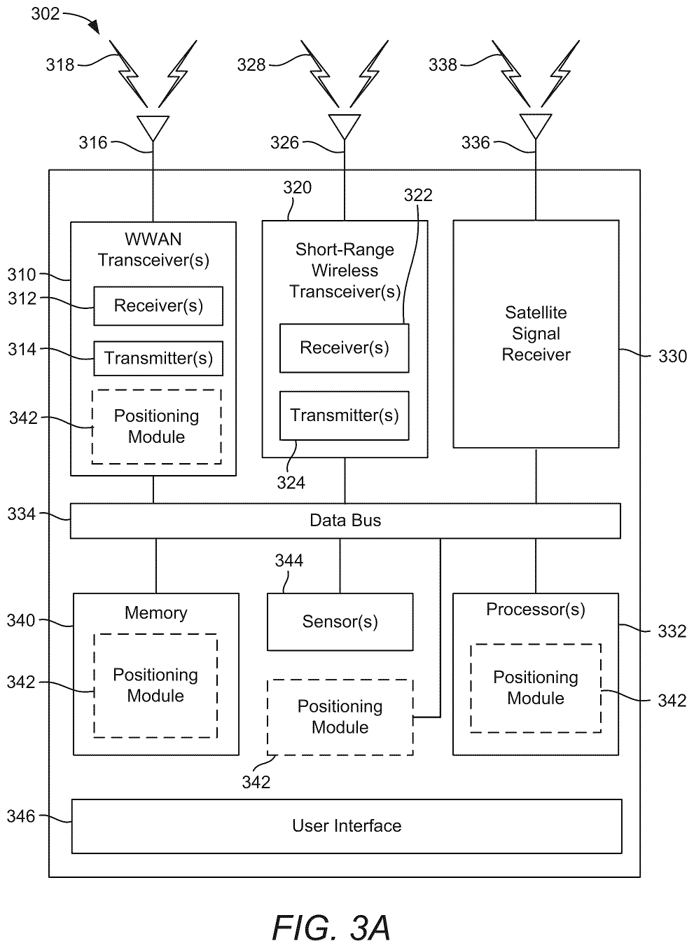

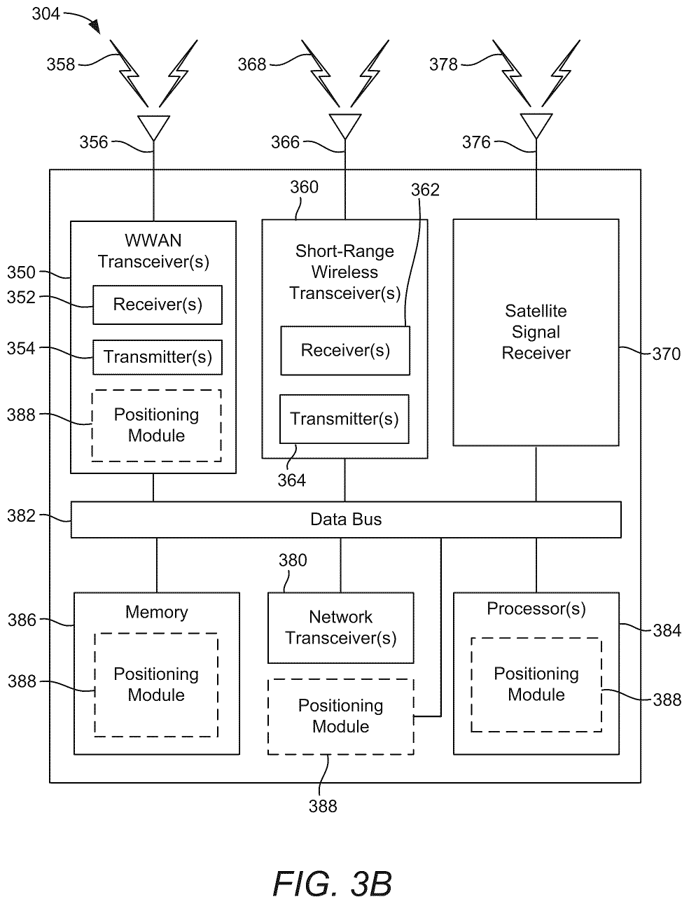

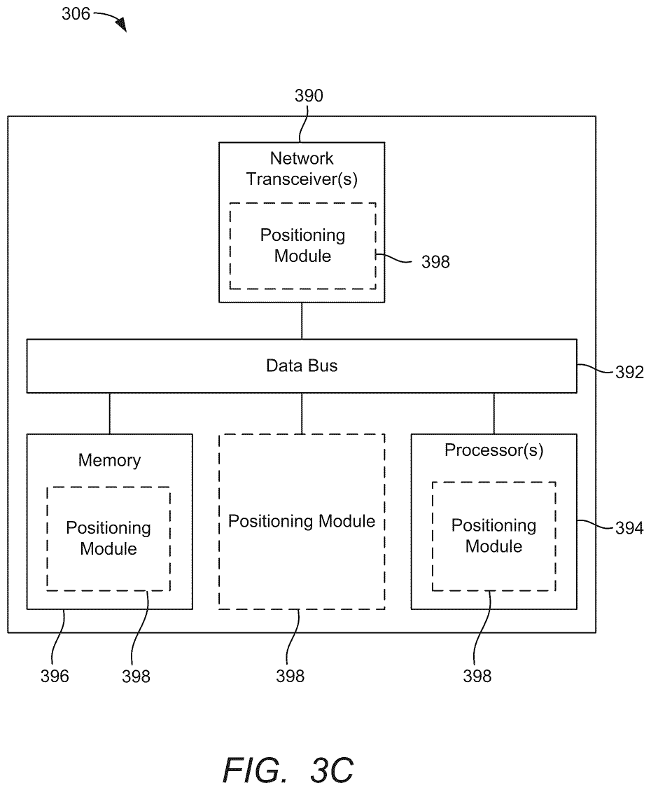

FIGS. 3A, 3B, and 3C are simplified block diagrams of several sample aspects of components that may be employed in a user equipment (UE), a base station, and a network entity, respectively, and configured to support communications as taught herein.

FIGS. 3A, 3B, and 3C illustrate several example components (represented by corresponding blocks) that may be incorporated into a UE 302 (which may correspond to any of the UEs described herein), a base station 304 (which may correspond to any of the base stations described herein), and a network entity 306 (which may correspond to or embody any of the network functions described herein, including the location server 230 and the LMF 270, or alternatively may be independent from the NG-RAN 220 and/or 5GC 210/260 infrastructure depicted in FIGS. 2A and 2B, such as a private network) to support the file transmission operations as taught herein. It will be appreciated that these components may be implemented in different types of apparatuses in different implementations (e.g., in an ASIC, in a system-on-chip (SoC), etc.). The illustrated components may also be incorporated into other apparatuses in a communication system. For example, other apparatuses in a system may include components similar to those described to provide similar functionality. Also, a given apparatus may contain one or more of the components. For example, an apparatus may include multiple transceiver components that enable the apparatus to operate on multiple carriers and/or communicate via different technologies.

The UE 302 and the base station 304 each include one or more wireless wide area network (WWAN) transceivers 310 and 350, respectively, providing means for communicating (e.g., means for transmitting, means for receiving, means for measuring, means for tuning, means for refraining from transmitting, etc.) via one or more wireless communication networks (not shown), such as an NR network, an LTE network, a GSM network, and/or the like. The WWAN transceivers 310 and 350 may each be connected to one or more antennas 316 and 356, respectively, for communicating with other network nodes, such as other UEs, access points, base stations (e.g., eNBs, gNBs), etc., via at least one designated RAT (e.g., NR, LTE, GSM, etc.) over a wireless communication medium of interest (e.g., some set of time/frequency resources in a particular frequency spectrum). The WWAN transceivers 310 and 350 may be variously configured for transmitting and encoding signals 318 and 358 (e.g., messages, indications, information, and so on), respectively, and conversely, for receiving and decoding signals 318 and 358 (e.g., messages, indications, information, pilots, and so on), respectively, in accordance with the designated RAT. Specifically, the WWAN transceivers 310 and 350 include one or more transmitters 314 and 354, respectively, for transmitting and encoding signals 318 and 358, respectively, and one or more receivers 312 and 352, respectively, for receiving and decoding signals 318 and 358, respectively.

The UE 302 and the base station 304 each also include, at least in some cases, one or more short-range wireless transceivers 320 and 360, respectively. The short-range wireless transceivers 320 and 360 may be connected to one or more antennas 326 and 366, respectively, and provide means for communicating (e.g., means for transmitting, means for receiving, means for measuring, means for tuning, means for refraining from transmitting, etc.) with other network nodes, such as other UEs, access points, base stations, etc., via at least one designated RAT (e.g., WiFi, LTE-D, Bluetooth®, Zigbee®, Z-Wave®, PC5, dedicated short-range communications (DSRC), wireless access for vehicular environments (WAVE), near-field communication (NFC), etc.) over a wireless communication medium of interest. The short-range wireless transceivers 320 and 360 may be variously configured for transmitting and encoding signals 328 and 368 (e.g., messages, indications, information, and so on), respectively, and conversely, for receiving and decoding signals 328 and 368 (e.g., messages, indications, information, pilots, and so on), respectively, in accordance with the designated RAT. Specifically, the short-range wireless transceivers 320 and 360 include one or more transmitters 324 and 364, respectively, for transmitting and encoding signals 328 and 368, respectively, and one or more receivers 322 and 362, respectively, for receiving and decoding signals 328 and 368, respectively. As specific examples, the short-range wireless transceivers 320 and 360 may be WiFi transceivers, Bluetooth® transceivers, Zigbee® and/or Z-Wave® transceivers, NFC transceivers, or vehicle-to-vehicle (V2V) and/or vehicle-to-everything (V2X) transceivers.

The UE 302 and the base station 304 also include, at least in some cases, satellite signal receivers 330 and 370. The satellite signal receivers 330 and 370 may be connected to one or more antennas 336 and 376, respectively, and may provide means for receiving and/or measuring satellite positioning/communication signals 338 and 378, respectively. Where the satellite signal receivers 330 and 370 are satellite positioning system receivers, the satellite positioning/communication signals 338 and 378 may be global positioning system (GPS) signals, global navigation satellite system (GLONASS) signals, Galileo signals, Beidou signals, Indian Regional Navigation Satellite System (NAVIC), Quasi-Zenith Satellite System (QZSS), etc. Where the satellite signal receivers 330 and 370 are non-terrestrial network (NTN) receivers, the satellite positioning/communication signals 338 and 378 may be communication signals (e.g., carrying control and/or user data) originating from a 5G network. The satellite signal receivers 330 and 370 may comprise any suitable hardware and/or software for receiving and processing satellite positioning/communication signals 338 and 378, respectively. The satellite signal receivers 330 and 370 may request information and operations as appropriate from the other systems, and, at least in some cases, perform calculations to determine locations of the UE 302 and the base station 304, respectively, using measurements obtained by any suitable satellite positioning system algorithm.

The base station 304 and the network entity 306 each include one or more network transceivers 380 and 390, respectively, providing means for communicating (e.g., means for transmitting, means for receiving, etc.) with other network entities (e.g., other base stations 304, other network entities 306). For example, the base station 304 may employ the one or more network transceivers 380 to communicate with other base stations 304 or network entities 306 over one or more wired or wireless backhaul links. As another example, the network entity 306 may employ the one or more network transceivers 390 to communicate with one or more base station 304 over one or more wired or wireless backhaul links, or with other network entities 306 over one or more wired or wireless core network interfaces.

A transceiver may be configured to communicate over a wired or wireless link. A transceiver (whether a wired transceiver or a wireless transceiver) includes transmitter circuitry (e.g., transmitters 314, 324, 354, 364) and receiver circuitry (e.g., receivers 312, 322, 352, 362). A transceiver may be an integrated device (e.g., embodying transmitter circuitry and receiver circuitry in a single device) in some implementations, may comprise separate transmitter circuitry and separate receiver circuitry in some implementations, or may be embodied in other ways in other implementations. The transmitter circuitry and receiver circuitry of a wired transceiver (e.g., network transceivers 380 and 390 in some implementations) may be coupled to one or more wired network interface ports. Wireless transmitter circuitry (e.g., transmitters 314, 324, 354, 364) may include or be coupled to a plurality of antennas (e.g., antennas 316, 326, 356, 366), such as an antenna array. that permits the respective apparatus (e.g., UE 302, base station 304) to perform transmit “beamforming,” as described herein. Similarly, wireless receiver circuitry (e.g., receivers 312, 322, 352, 362) may include or be coupled to a plurality of antennas (e.g., antennas 316, 326, 356. 366), such as an antenna array. that permits the respective apparatus (e.g., UE 302, base station 304) to perform receive beamforming, as described herein. In an aspect, the transmitter circuitry and receiver circuitry may share the same plurality of antennas (e.g., antennas 316, 326. 356, 366), such that the respective apparatus can only receive or transmit at a given time, not both at the same time. A wireless transceiver (e.g., WWAN transceivers 310 and 350, short-range wireless transceivers 320 and 360) may also include a network listen module (NLM) or the like for performing various measurements.

As used herein, the various wireless transceivers (e.g., transceivers 310, 320, 350, and 360, and network transceivers 380 and 390 in some implementations) and wired transceivers (e.g., network transceivers 380 and 390 in some implementations) may generally be characterized as “a transceiver.” “at least one transceiver,” or “one or more transceivers.” As such, whether a particular transceiver is a wired or wireless transceiver may be inferred from the type of communication performed. For example, backhaul communication between network devices or servers will generally relate to signaling via a wired transceiver, whereas wireless communication between a UE (e.g., UE 302) and a base station (e.g., base station 304) will generally relate to signaling via a wireless transceiver.

The UE 302, the base station 304, and the network entity 306 also include other components that may be used in conjunction with the operations as disclosed herein. The UE 302, the base station 304, and the network entity 306 include one or more processors 332, 384, and 394, respectively, for providing functionality relating to, for example, wireless communication, and for providing other processing functionality. The processors 332, 384, and 394 may therefore provide means for processing, such as means for determining, means for calculating, means for receiving, means for transmitting, means for indicating, etc. In an aspect, the processors 332, 384, and 394 may include, for example, one or more general purpose processors, multi-core processors, central processing units (CPUs), ASICs, digital signal processors (DSPs), field programmable gate arrays (FPGAs), other programmable logic devices or processing circuitry, or various combinations thereof.

The UE 302, the base station 304, and the network entity 306 include memory circuitry implementing memories 340, 386, and 396 (e.g., each including a memory device), respectively, for maintaining information (e.g., information indicative of reserved resources, thresholds, parameters, and so on). The memories 340, 386, and 396 may therefore provide means for storing, means for retrieving, means for maintaining, etc. In some cases, the UE 302, the base station 304, and the network entity 306 may include positioning module 342, 388, and 398, respectively. The positioning module 342, 388, and 398 may be hardware circuits that are part of or coupled to the processors 332, 384, and 394, respectively, that, when executed, cause the UE 302, the base station 304, and the network entity 306 to perform the functionality described herein. In other aspects, the positioning module 342, 388, and 398 may be external to the processors 332, 384, and 394 (e.g., part of a modem processing system, integrated with another processing system, etc.). Alternatively, the positioning module 342, 388, and 398 may be memory modules stored in the memories 340, 386, and 396, respectively, that, when executed by the processors 332, 384, and 394 (or a modem processing system, another processing system, etc.), cause the UE 302, the base station 304, and the network entity 306 to perform the functionality described herein. FIG. 3A illustrates possible locations of the positioning module 342, which may be, for example, part of the one or more WWAN transceivers 310, the memory 340, the one or more processors 332, or any combination thereof, or may be a standalone component. FIG. 3B illustrates possible locations of the positioning module 388, which may be, for example, part of the one or more WWAN transceivers 350, the memory 386, the one or more processors 384, or any combination thereof, or may be a standalone component. FIG. 3C illustrates possible locations of the positioning module 398, which may be, for example, part of the one or more network transceivers 390, the memory 396, the one or more processors 394, or any combination thereof, or may be a standalone component.

The UE 302 may include one or more sensors 344 coupled to the one or more processors 332 to provide means for sensing or detecting movement and/or orientation information that is independent of motion data derived from signals received by the one or more WWAN transceivers 310, the one or more short-range wireless transceivers 320, and/or the satellite signal receiver 330. By way of example, the sensor(s) 344 may include an accelerometer (e.g., a micro-electrical mechanical systems (MEMS) device), a gyroscope, a geomagnetic sensor (e.g., a compass), an altimeter (e.g., a barometric pressure altimeter), and/or any other type of movement detection sensor. Moreover, the sensor(s) 344 may include a plurality of different types of devices and combine their outputs in order to provide motion information. For example, the sensor(s) 344 may use a combination of a multi-axis accelerometer and orientation sensors to provide the ability to compute positions in two-dimensional (2D) and/or three-dimensional (3D) coordinate systems.

In addition, the UE 302 includes a user interface 346 providing means for providing indications (e.g., audible and/or visual indications) to a user and/or for receiving user input (e.g., upon user actuation of a sensing device such a keypad, a touch screen, a microphone, and so on). Although not shown, the base station 304 and the network entity 306 may also include user interfaces.

Referring to the one or more processors 384 in more detail, in the downlink, IP packets from the network entity 306 may be provided to the processor 384. The one or more processors 384 may implement functionality for an RRC layer, a packet data convergence protocol (PDCP) layer, a radio link control (RLC) layer, and a medium access control (MAC) layer. The one or more processors 384 may provide RRC layer functionality associated with broadcasting of system information (e.g., master information block (MIB), system information blocks (SIBs)), RRC connection control (e.g., RRC connection paging. RRC connection establishment, RRC connection modification, and RRC connection release), inter-RAT mobility, and measurement configuration for UE measurement reporting; PDCP layer functionality associated with header compression/decompression, security (ciphering, deciphering, integrity protection, integrity verification), and bandover support functions; RLC layer functionality associated with the transfer of upper layer PDUs, error correction through automatic repeat request (ARQ), concatenation, segmentation, and reassembly of RLC service data units (SDUs), re-segmentation of RLC data PDUs, and reordering of RLC data PDUs; and MAC layer functionality associated with mapping between logical channels and transport channels, scheduling information reporting, error correction, priority handling, and logical channel prioritization.

The transmitter 354 and the receiver 352 may implement Layer-1 (L1) functionality associated with various signal processing functions. Layer-1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The transmitter 354 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an orthogonal frequency division multiplexing (OFDM) subcarrier, multiplexed with a reference signal (e.g., pilot) in the time and/or frequency domain, and then combined together using an inverse fast Fourier transform (IFFT) to produce a physical channel carrying a time domain OFDM symbol stream. The OFDM symbol stream is spatially precoded to produce multiple spatial streams. Channel estimates from a channel estimator may be used to determine the coding and modulation scheme, as well as for spatial processing. The channel estimate may be derived from a reference signal and/or channel condition feedback transmitted by the UE 302. Each spatial stream may then be provided to one or more different antennas 356. The transmitter 354 may modulate an RF carrier with a respective spatial stream for transmission.

At the UE 302, the receiver 312 receives a signal through its respective antenna(s) 316. The receiver 312 recovers information modulated onto an RF carrier and provides the information to the one or more processors 332. The transmitter 314 and the receiver 312 implement Layer-1 functionality associated with various signal processing functions. The receiver 312 may perform spatial processing on the information to recover any spatial streams destined for the UE 302. If multiple spatial streams are destined for the UE 302, they may be combined by the receiver 312 into a single OFDM symbol stream. The receiver 312 then converts the OFDM symbol stream from the time-domain to the frequency domain using a fast Fourier transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 304. These soft decisions may be based on channel estimates computed by a channel estimator. The soft decisions are then decoded and de-interleaved to recover the data and control signals that were originally transmitted by the base station 304 on the physical channel. The data and control signals are then provided to the one or more processors 332, which implements Layer-3 (L3) and Layer-2 (L2) functionality.

In the uplink, the one or more processors 332 provides demultiplexing between transport and logical channels, packet reassembly, deciphering, header decompression, and control signal processing to recover IP packets from the core network. The one or more processors 332 are also responsible for error detection.

Similar to the functionality described in connection with the downlink transmission by the base station 304, the one or more processors 332 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through hybrid automatic repeat request (HARQ), priority handling, and logical channel prioritization.

Channel estimates derived by the channel estimator from a reference signal or feedback transmitted by the base station 304 may be used by the transmitter 314 to select the appropriate coding and modulation schemes, and to facilitate spatial processing. The spatial streams generated by the transmitter 314 may be provided to different antenna(s) 316. The transmitter 314 may modulate an RF carrier with a respective spatial stream for transmission.

The uplink transmission is processed at the base station 304 in a manner similar to that described in connection with the receiver function at the UE 302. The receiver 352 receives a signal through its respective antenna(s) 356. The receiver 352 recovers information modulated onto an RF carrier and provides the information to the one or more processors 384.

In the uplink, the one or more processors 384 provides demultiplexing between transport and logical channels, packet reassembly, deciphering, header decompression, control signal processing to recover IP packets from the UE 302. IP packets from the one or more processors 384 may be provided to the core network. The one or more processors 384 are also responsible for error detection.

For convenience, the UE 302, the base station 304, and/or the network entity 306 are shown in FIGS. 3A, 3B, and 3C as including various components that may be configured according to the various examples described herein. It will be appreciated, however, that the illustrated components may have different functionality in different designs. In particular, various components in FIGS. 3A to 3C are optional in alternative configurations and the various aspects include configurations that may vary due to design choice, costs, use of the device, or other considerations. For example, in case of FIG. 3A, a particular implementation of UE 302 may omit the WWAN transceiver(s) 310 (e.g., a wearable device or tablet computer or PC or laptop may have Wi-Fi and/or Bluetooth capability without cellular capability), or may omit the short-range wireless transceiver(s) 320 (e.g., cellular-only, etc.), or may omit the satellite signal receiver 330, or may omit the sensor(s) 344, and so on. In another example, in case of FIG. 3B, a particular implementation of the base station 304 may omit the WWAN transceiver(s) 350 (e.g., a Wi-Fi “hotspot” access point without cellular capability), or may omit the short-range wireless transceiver(s) 360 (e.g., cellular-only, etc.), or may omit the satellite receiver 370, and so on. For brevity. illustration of the various alternative configurations is not provided herein, but would be readily understandable to one skilled in the art.

The various components of the UE 302, the base station 304, and the network entity 306 may be communicatively coupled to each other over data buses 334, 382, and 392, respectively. In an aspect, the data buses 334, 382, and 392 may form, or be part of, a communication interface of the UE 302, the base station 304, and the network entity 306, respectively. For example, where different logical entities are embodied in the same device (e.g., gNB and location server functionality incorporated into the same base station 304), the data buses 334, 382, and 392 may provide communication between them.

The components of FIGS. 3A, 3B, and 3C may be implemented in various ways. In some implementations, the components of FIGS. 3A, 3B, and 3C may be implemented in one or more circuits such as, for example, one or more processors and/or one or more ASICs (which may include one or more processors). Here, each circuit may use and/or incorporate at least one memory component for storing information or executable code used by the circuit to provide this functionality. For example, some or all of the functionality represented by blocks 310 to 346 may be implemented by processor and memory component(s) of the UE 302 (e.g., by execution of appropriate code and/or by appropriate configuration of processor components). Similarly, some or all of the functionality represented by blocks 350 to 388 may be implemented by processor and memory component(s) of the base station 304 (e.g., by execution of appropriate code and/or by appropriate configuration of processor components). Also, some or all of the functionality represented by blocks 390 to 398 may be implemented by processor and memory component(s) of the network entity 306 (e.g., by execution of appropriate code and/or by appropriate configuration of processor components). For simplicity, various operations, acts, and/or functions are described herein as being performed “by a UE,” “by a base station.” “by a network entity,” etc. However, as will be appreciated, such operations, acts, and/or functions may actually be performed by specific components or combinations of components of the UE 302, base station 304, network entity 306, etc., such as the processors 332, 384, 394, the transceivers 310, 320, 350, and 360, the memories 340, 386, and 396, the positioning module 342, 388, and 398, etc.

In some designs, the network entity 306 may be implemented as a core network component. In other designs, the network entity 306 may be distinct from a network operator or operation of the cellular network infrastructure (e.g., NG RAN 220 and/or 5GC 210/260). For example, the network entity 306 may be a component of a private network that may be configured to communicate with the UE 302 via the base station 304 or independently from the base station 304 (e.g., over a non-cellular communication link, such as WiFi).

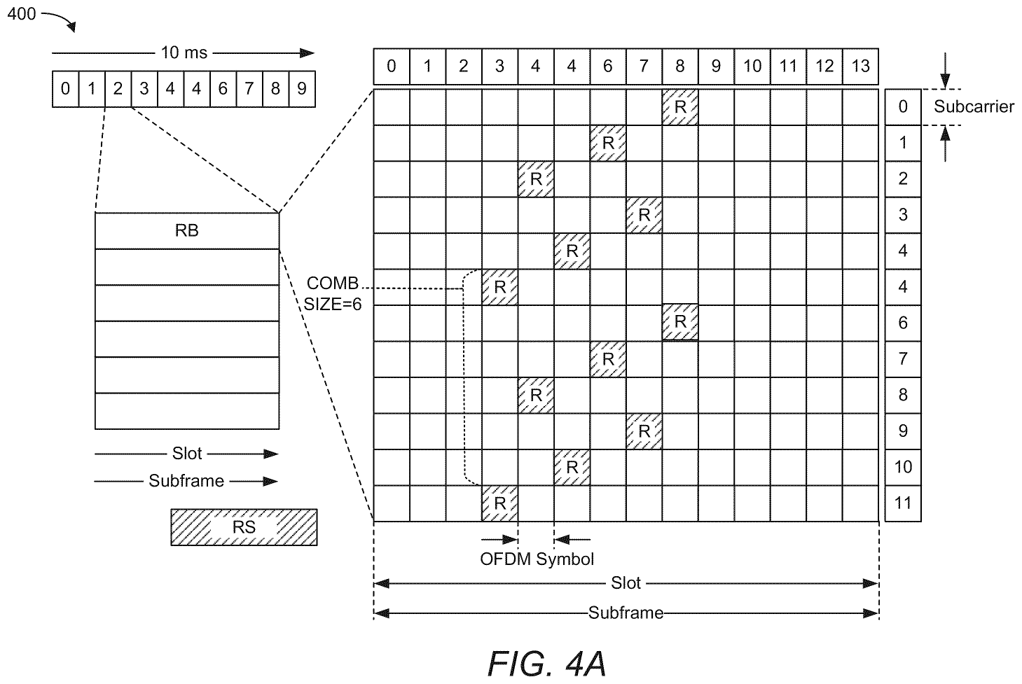

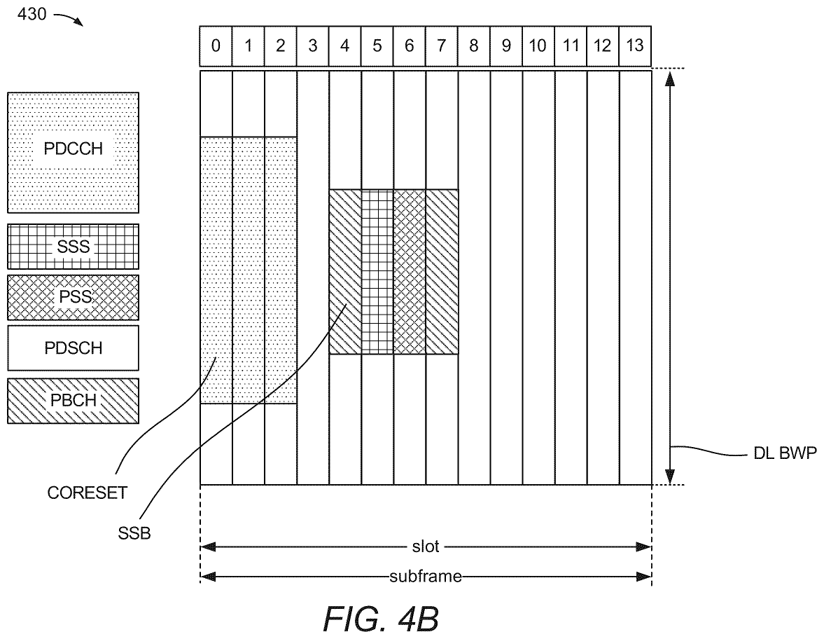

FIGS. 4A and 4B are diagrams illustrating example frame structures and channels within the frame structures. FIG. 4A is a diagram 400 illustrating an example of a downlink frame structure, and FIG. 4B is a diagram 430 illustrating an example of channels within the downlink frame structure. Other wireless communications technologies may have different frame structures, different channels, or both.

LTE, and in some cases NR, utilizes OFDM on the downlink and single-carrier frequency division multiplexing (SC-FDM) on the uplink. Unlike LTE, however, NR has an option to use OFDM on the uplink as well. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, the spacing of the subcarriers may be 15 kHz and the minimum resource allocation (resource block) may be 12 subcarriers (or 180 kHz). Consequently, the nominal FFT size may be equal to 128, 256, 504, 1024, or 2048 for system bandwidth of 1.25, 2.5, 5, 10, or 20 megahertz (MHz), respectively. The system bandwidth may also be partitioned into subbands. For example, a subband may cover 1.8 MHz (i.e., 6 resource blocks), and there may be 1, 2, 4, 8, or 16 subbands for system bandwidth of 1.25, 2.5, 5, 10, or 20 MHz, respectively.

LTE supports a single numerology (subcarrier spacing, symbol length, etc.). In contrast, NR may support multiple numerologies (u), for example, subcarrier spacing of 15 kHz, 30 kHz, 60 kHz, 120 kHz, and 240 kHz or greater may be available. Table 1 provided below lists some various parameters for different NR numerologies.

TABLE 1

| | | | | | | | Max. nominal |
|---|---|---|---|---|---|---|---|
| | | | | | Slot | Symbol | system BW |
| | SCS | Symbols/ | Slots/ | Slots/ | Duration | Duration | (MHz) with |
| μ | (kHz) | Sot | Subframe | Frame | (ms) | (μs) | 4K FFT size |
| 0 | 15 | 14 | 1 | 10 | 1 | 66.7 | 50 |
| 1 | 30 | 14 | 2 | 20 | 0.5 | 33.3 | 100 |
| 2 | 60 | 14 | 4 | 40 | 0.25 | 16.7 | 200 |
| 3 | 120 | 14 | 8 | 80 | 0.125 | 8.33 | 400 |
| 4 | 240 | 14 | 16 | 160 | 0.0625 | 4.17 | 800 |

In the example of FIGS. 4A and 4B, a numerology of 15 kHz is used. Thus, in the time domain, a 10 millisecond (ms) frame is divided into 10 equally sized subframes of 1 ms each, and each subframe includes one time slot. In FIGS. 4A and 4B, time is represented horizontally (e.g., on the X axis) with time increasing from left to right, while frequency is represented vertically (e.g., on the Y axis) with frequency increasing (or decreasing) from bottom to top.

A resource grid may be used to represent time slots, each time slot including one or more time-concurrent resource blocks (RBs) (also referred to as physical RBs (PRBs)) in the frequency domain. The resource grid is further divided into multiple resource elements (REs). An RE may correspond to one symbol length in the time domain and one subcarrier in the frequency domain. In NR, a subframe is 1 ms in duration, a slot is fourteen symbols in the time domain, and an RB contains twelve consecutive subcarriers in the frequency domain and fourteen consecutive symbols in the time domain. Thus, in NR there is one RB per slot. Depending on the SCS, an NR subframe may have fourteen symbols, twenty-eight symbols, or more, and thus may have 1 slot, 2 slots, or more. The number of bits carried by each RE depends on the modulation scheme.

Some of the REs carry downlink reference (pilot) signals (DL-RS). The DL-RS may include PRS, TRS, PTRS, CRS, CSI-RS, DMRS, PSS, SSS, SSB, etc. FIG. 4A illustrates exemplary locations of REs carrying PRS (labeled “R”).

A “PRS instance” or “PRS occasion” is one instance of a periodically repeated time window (e.g., a group of one or more consecutive slots) where PRS are expected to be transmitted. A PRS occasion may also be referred to as a “PRS positioning occasion,” a “PRS positioning instance, a “positioning occasion,” “a positioning instance,” a “positioning repetition,” or simply an “occasion,” an “instance,” or a “repetition.”

A collection of resource elements (REs) that are used for transmission of PRS is referred to as a “PRS resource.” The collection of resource elements can span multiple PRBs in the frequency domain and ‘N’ (e.g., 1 or more) consecutive symbol(s) within a slot in the time domain. In a given OFDM symbol in the time domain, a PRS resource occupies consecutive PRBs in the frequency domain.

The transmission of a PRS resource within a given PRB has a particular comb size (also referred to as the “comb density”). A comb size ‘N’ represents the subcarrier spacing (or frequency/tone spacing) within each symbol of a PRS resource configuration. Specifically, for a comb size ‘N,’ PRS are transmitted in every Nth subcarrier of a symbol of a PRB. For example, for comb-4, for each of the fourth symbols of the PRS resource configuration, REs corresponding to every fourth subcarrier (e.g., subcarriers 0, 4, 8) are used to transmit PRS of the PRS resource. Currently, comb sizes of comb-2, comb-4, comb-6, and comb-12 are supported for DL PRS. FIG. 4A illustrates an exemplary PRS resource configuration for comb-6 (which spans six symbols). That is, the locations of the shaded REs (labeled “R”) indicate a comb-6 PRS resource configuration.

A “PRS resource set” is a set of PRS resources used for the transmission of PRS signals, where each PRS resource has a PRS resource ID. In addition, the PRS resources in a PRS resource set are associated with the same TRP. A PRS resource set is identified by a PRS resource set ID and is associated with a particular TRP (identified by a TRP ID). In addition, the PRS resources in a PRS resource set have the same periodicity, a common muting pattern configuration, and the same repetition factor (e.g., PRS-ResourceRepetitionFactor) across slots. The periodicity is the time from the first repetition of the first PRS resource of a first PRS instance to the same first repetition of the same first PRS resource of the next PRS instance. The periodicity may have a length selected from 2^{μ}·{4, 5, 8, 10, 16, 20, 32, 40, 64, 80, 160, 320, 640, 1280, 2560, 5040, 10240} slots, with μ=0, 1, 2, 3. The repetition factor may have a length selected from {1, 2, 4, 6, 8, 16, 32} slots.

A PRS resource ID in a PRS resource set is associated with a single beam (or beam ID) transmitted from a single TRP (where a TRP may transmit one or more beams). That is, each PRS resource of a PRS resource set may be transmitted on a different beam, and as such, a “PRS resource,” or simply “resource,” can also be referred to as a “beam.” Note that this does not have any implications on whether the TRPs and the beams on which PRS are transmitted are known to the UE.

A “positioning frequency layer” (also referred to simply as a “frequency layer”) is a collection of one or more PRS resource sets across one or more TRPs that have the same values for certain parameters. Specifically, the collection of PRS resource sets has the same subcarrier spacing (SCS) and cyclic prefix (CP) type (meaning all numerologies supported for the PDSCH are also supported for PRS), the same Point A, the same value of the downlink PRS bandwidth, the same start PRB (and center frequency), and the same comb-size. The Point A parameter takes the value of the parameter ARFCN-ValueNR (where “ARFCN” stands for “absolute radio-frequency channel number”) and is an identifier/code that specifies a pair of physical radio channel used for transmission and reception. The downlink PRS bandwidth may have a granularity of four PRBs, with a minimum of 24 PRBs and a maximum of 272 PRBs. Currently, up to four frequency layers have been defined, and up to two PRS resource sets may be configured per TRP per frequency layer.

The concept of a frequency layer is somewhat like the concept of component carriers and bandwidth parts (BWPs), but different in that component carriers and BWPs are used by one base station (or a macro cell base station and a small cell base station) to transmit data channels, while frequency layers are used by several (usually three or more) base stations to transmit PRS. A UE may indicate the number of frequency layers it can support when it sends the network its positioning capabilities, such as during an LTE positioning protocol (LPP) session. For example, a UE may indicate whether it can support one or four positioning frequency layers.

FIG. 4B illustrates an example of various channels within a downlink slot of a radio frame. In NR, the channel bandwidth, or system bandwidth, is divided into multiple BWPs. A BWP is a contiguous set of PRBs selected from a contiguous subset of the common RBs for a given numerology on a given carrier. Generally, a maximum of four BWPs can be specified in the downlink and uplink. That is, a UE can be configured with up to four BWPs on the downlink, and up to four BWPs on the uplink. Only one BWP (uplink or downlink) may be active at a given time, meaning the UE may only receive or transmit over one BWP at a time. On the downlink, the bandwidth of each BWP should be equal to or greater than the bandwidth of the SSB, but it may or may not contain the SSB.

Referring to FIG. 4B, a primary synchronization signal (PSS) is used by a UE to determine subframe/symbol timing and a physical layer identity. A secondary synchronization signal (SSS) is used by a UE to determine a physical layer cell identity group number and radio frame timing. Based on the physical layer identity and the physical layer cell identity group number, the UE can determine a PCI. Based on the PCI, the UE can determine the locations of the aforementioned DL-RS. The physical broadcast channel (PBCH), which carries an MIB, may be logically grouped with the PSS and SSS to form an SSB (also referred to as an SS/PBCH). The MIB provides a number of RBs in the downlink system bandwidth and a system frame number (SFN). The physical downlink shared channel (PDSCH) carries user data, broadcast system information not transmitted through the PBCH, such as system information blocks (SIBs), and paging messages.

The physical downlink control channel (PDCCH) carries downlink control information (DCI) within one or more control channel elements (CCEs), each CCE including one or more RE group (REG) bundles (which may span multiple symbols in the time domain), each REG bundle including one or more REGs, each REG corresponding to 12 resource elements (one resource block) in the frequency domain and one OFDM symbol in the time domain. The set of physical resources used to carry the PDCCH/DCI is referred to in NR as the control resource set (CORESET). In NR, a PDCCH is confined to a single CORESET and is transmitted with its own DMRS. This enables UE-specific beamforming for the PDCCH.

In the example of FIG. 4B, there is one CORESET per BWP, and the CORESET spans three symbols (although it could be only one or two symbols) in the time domain. Unlike LTE control channels, which occupy the entire system bandwidth, in NR, PDCCH channels are localized to a specific region in the frequency domain (i.e., a CORESET). Thus, the frequency component of the PDCCH shown in FIG. 4B is illustrated as less than a single BWP in the frequency domain. Note that although the illustrated CORESET is contiguous in the frequency domain, it need not be. In addition, the CORESET may span less than three symbols in the time domain.

The DCI within the PDCCH carries information about uplink resource allocation (persistent and non-persistent) and descriptions about downlink data transmitted to the UE. Multiple (e.g., up to eight) DCIs can be configured in the PDCCH, and these DCIs can have one of multiple formats. For example, there are different DCI formats for uplink scheduling, for non-MIMO downlink scheduling, for MIMO downlink scheduling, and for uplink power control. A PDCCH may be transported by 1, 2, 4, 8, or 16 CCEs in order to accommodate different DCI payload sizes or coding rates.

Positioning reference signals are defined for NR positioning to enable UEs to detect and measure more neighbor TRPs. Several configurations are supported to enable a variety of deployments, such as indoor, outdoor, sub-6, and millimeter wave (mmW) deployments. Both UE assisted and UE based position calculation is supported:

TABLE 2

| Reference Signals | UE Measurements | Positioning techniques |
|---|---|---|
| DL PRS | DL RSTD | DL-TDOA |
| DL PRS | DL PRS RSRP | DL-TDOA, DL-AoD, |
| | | Multi-RTT |
| DL PRS/SRS for | UE Rx-Tx time | Multi-RTT |
| positioning | difference | |
| SSB/CSI-RS for | SS-RSRP (for RRM), | E-CID |
| RRM | SS-RSRQ (for RRM), | |
| | CSI-RSRP (for RRM), | |
| | CSI-RSRQ (for RRM) | |

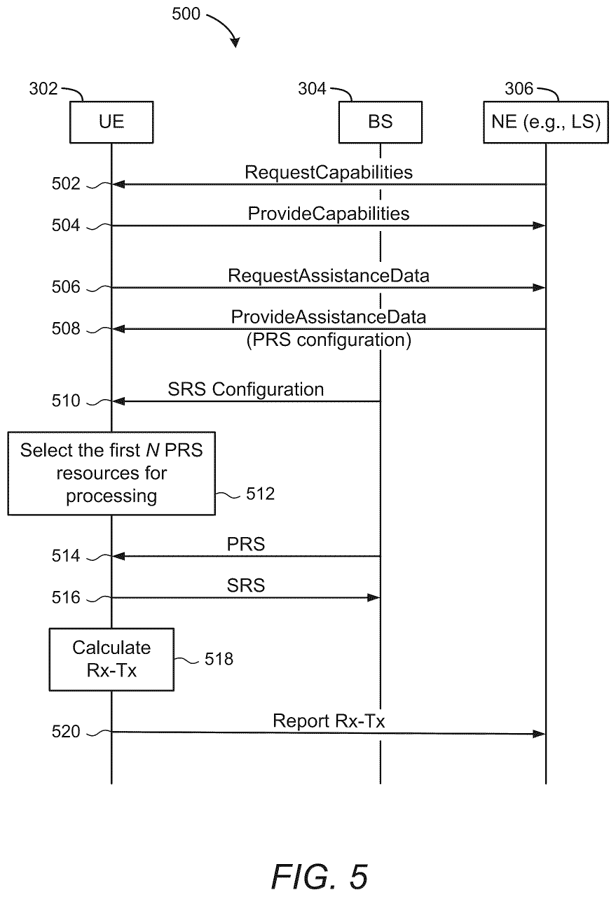

In conventional systems, a UE may report its capability to process PRSs via a capability update, and may receive, e.g., from an LMF, assistance data (AD) for PRS measurements. This is illustrated in FIG. 5.

FIG. 5 is a signaling message and event diagram illustrating conventional prioritization of UL and DL positioning resources. FIG. 5 shows an interaction between a UE 302, a base station (BS) 304, and a network entity (NE) 306, which may be a location server (e.g., location server 172, LMF 270, or SLP 272). In the example shown in FIG. 5, the network entity 306 sends a request message 502 for capability information from the UE 302, and the UE provides capability information to the network entity 306 in a response message 504. The UE sends a request message 506 for assistance data from the network entity, and the network entity provides assistance data to the UE 302 in a response message 508. In some aspects, the assistance data includes a PRS configuration that identifies a set of M PRS resources. Examples of PRS resources include, but are not limited to, positioning reference signal (PRS) resources, PRS resource sets. PRS frequency layers, transmission/reception points (TRPs), cells, or combinations thereof. The UE may presume that the PRS resources identified in the assistance data are sorted in a decreasing order of measurement priority. For example, the following priority may be assumed:
the four frequency layers are sorted according to priority;
the sixty-four TRPs per frequency layer are sorted according to priority;
the two sets per TRP of the frequency layer are sorted according to priority;
the sixty-four resource of the set per TRP per frequency layer are sorted according to priority; and
the reference indicated by nr-DL-PRS-ReferenceInfo-r16 for each frequency layer has the highest priority at least for DL-TDOA.

In conventional networks, priority assignment is completely based on the PRS measurements.

In FIG. 5, the UE receives, from the base station 304, an SRS configuration message 510, which may be received via RRC. It is noted that the order of the messages in 502, 504, 506, 508, and 510 are illustrative and not limiting, i.e., the specific order of those elements in FIG. 5 may vary. For example, the UE 302 may receive the PRS configuration information after receiving the SRS configuration, and vice versa. Likewise, the UE 302 may receive information in response to a specific request for that information, or it may receive that information unilaterally, i.e., without having made a specific request for it.

The PRS configuration information typically defines or identifies more PRS resources than the UE has the capability to process, and so the UE has to select some subset of PRS resources to process (block 512), while the remaining unselected PRS resources identified in the PRS configuration are ignored and not processed. Where M is the number of PRS resources identified by the PRS configuration and N is the number of PRS resources that the UE can process. where N<M, then by current agreement, the UE will simply select the first N PRS resources identified in the assistance data. The UE 302 then processes one or more of the prioritized PRS resources 514 and uses that information to determine, for example, a transmission power for an SRS message 516. In FIG. 5, the UE 302 can then calculate Rx-Tx (block 518) and report that calculation to the network node 306 (message 520).

There are several issues with the conventional method illustrated in FIG. 5. One issue is that PRS resources are provided to the UE by the location server, but the SRS configuration is provided to the UE by a serving base station, e.g., via a radio resource control (RRC) message, which means that the location server is not aware of SRS scheduling and prioritizes the PRS resources solely on PRS measurements without consideration of SRS. As a result, when a UE selects the first N PRS resources defined in the AD per the agreement described above, some of the PRS resources selected may be less than optimal. Some examples of sub-optimal prioritization of PRS resources are shown below.

To perform an Rx-Ty measurement, a UE must perform both a PRS measurement and an SRS transmission, and in order to get an accurate Rx-Tx measurement, the PRS and SRS should be relatively proximate in time, e.g., to minimize error due to possible clock drift between the UE and the base station. Current standards state that PRS and SRS must be no more than 25 milliseconds (msec) apart in time.

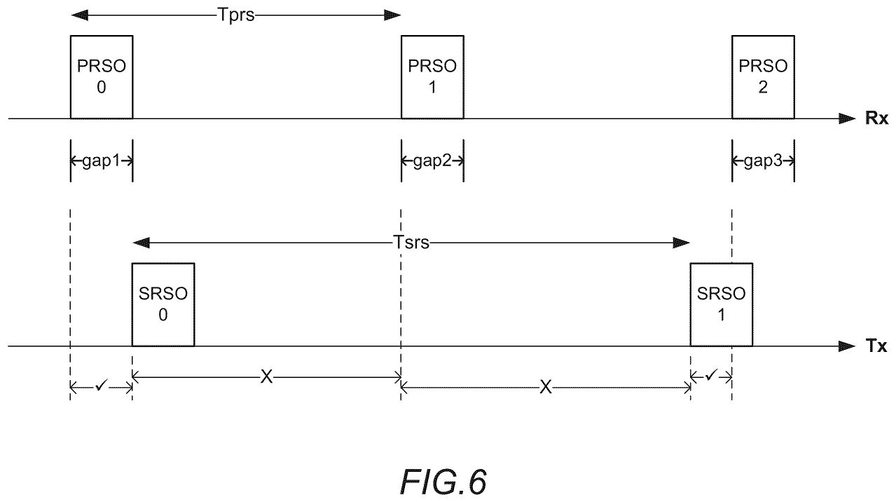

FIG. 6 shows an example scenario in which PRS occasions (PRSO0, PRSO1, and PRSO2, each in a different measurement gap) have a different period than SRS occasions (SRSO0 and SRSO1), e.g., T_{PRS} is different than T_{SRS}. Under the conventional prioritization method, the first N PRS resources in the PRS configuration will be selected, without consideration of the time proximity requirements. As a result, some PRS-SRS pairs may not satisfy the time proximity requirements. In FIG. 6, for example, the PRS resources in PRSO0 paired with SRS resources in SRSO0 satisfy the proximity requirement, but PRS resources in PRSO1 paired with SRS resources in SRSO1 do not, a sub-optimal prioritization of PRS resources.

Several approaches to this problem are being considered. One approach being considered is to apply the proximity timing requirement only if any SRS transmission is within 25 ms of at least one DL PRS resource of each of the TRPs in the assistance data. Another approach being considered is to apply the proximity timing requirement only if there is at least one SRS transmission within the measurement period. Yet another approach being considered is to always apply the proximity timing requirement regardless of the time separation between PRS and SRS, but to require the UE to compensate for the difference in the received timing of the radio frame containing the PRS and the subframe used for transmitting the SRS.

Yet another issue is related to the fact that the number of PRS resources specified in the assistance data (M) may be more than the number of PRS resources that the UE can process (N), and that the UE simply selects the first N PRS resources for processing. While reporting its capabilities to a network node (e.g., message 504 in FIG. 5), a UE can indicate whether it supports open loop power control (OLPC) for SRS positioning. This capability signaling comprises the following parameters:
olpc-SRS-PosBasedOnPRS-Serving-r16 indicates whether the UE supports OLPC for SRS positioning based on PRS from the serving cell in the same band;
olpc-SRS-PosBasedOnSSB-Neigh-r16 indicates whether the UE supports OLPC for SRS positioning based on SSB from the neighboring cell in the same band;
olpc-SRS-PosBasedOnPRS-Neigh-r16 indicates whether the UE supports OLPC for SRS positioning based on PRS from the neighboring cell in the same band; and
maxNumberPathLossEstimatePerServing-r16 indicates the maximum number of pathloss estimates that the UE can simultaneously maintain for all the SRS resource sets for positioning per serving cell in addition to the up to four pathloss estimates that the UE maintains per serving cell for the PUSCH/PUCCH/SRS transmissions.
   Depending on the configuration, different SRS resource sets can be transmitted with the same or different power from each other, and the same SRS resource set may be transmitted with different power in different SRS occasions.

The UE can further indicate whether its supports spatial relations for SRS for positioning, currently only applicable for frequency range 2 (FR2). This capability signaling comprises the following parameters:
spatialRelation-SRS-PosBasedOnSSB-Serving indicates whether the UE supports spatial relation for SRS for positioning based on SSB from the serving cell in the same band;
spatialRelation-SRS-PosBasedOnCSI-RS-Serving indicates whether the UE supports spatial relation for SRS positioning based on CSI-RS from the serving cell in the same band;
spatialRelation-SRS-PosBasedOnPRS-Serving indicates whether the UE supports spatial relation for SRS for positioning based on PRS from the serving cell in the same band;
spatialRelation-SRS-PosBasedOnSRS indicates whether the UE supports spatial relation for SRS for positioning based on SRS in the same band;
spatialRelation-SRS-PosBasedOnSSB-Neigh indicates whether the UE supports spatial relation for SRS for positioning based on SSB from the neighboring cell in the same band; and
spatialRelation-SRS-PosBasedOnPRS-Neigh indicates whether the UE supports spatial relation for SRS for positioning based on PRS from the neighboring cell in the same band.
   Depending on the configuration, different SRS resource sets can be transmitted with the same or different spatial properties (e.g., beam shape or direction) from each other, and the same SRS resource set may be transmitted with different spatial properties or direction in different SRS occasions.

The UE is provided with information that associates each SRS with at least one specific PRS to be used by the UE as a reference for that specific SRS. An example of this information in table form is shown below:

TABLE 3

| Pathloss Group | SRS Set | PRS Group |
|---|---|---|
| Group 1 | SRS Set 1 | PRS{1 3, 5} |
| Group 2 | SRS Set 2 | PRS{2, 4, 6} |
| Group 3 | SRS Set 3 | PRS{8, 9, 11} |
| Group 4 | SRS Set 4 | PRS{10, 7, 12} |

An SRS set corresponds to one or more SRS resources or SRS resource sets that all appear in the time-domain between two PRS instances. For example, SRS set 1 in the table above may can be X number of SRS resources, each one using a single PRS as reference, or Y number of sets, each one using one or more PRS as references. That is, an “SRS set” is a collection of SRS instances that happen between PRS occasions, i.e., between two measurement gaps.

A PRS group is a collection of all of the PRS resources being used as references for SRS instances within an SRS set. A PRS group may correspond to one or more PRS resources or PRS resource sets. Each SRS in an SRS set can have up to two PRS references: one for pathloss and another for the spatial properties, or one for both pathloss and spatial properties. Currently, SRS spatial relations are defined for individual SRS resources, but SRS power factors are defined for SRS sets, not for individual resources.

As illustrated in the table above, each SRS set is associated with a pathloss group, and thus each SRS set is associated with a transmit power. The serving gNB may create these groups and may provide the grouping to the UE. The number of pathloss groups defined is constrained by the value of the parameter maxNumberPathLossEstimatePerServing-r16.

Referring to the example in the table above, SRS resources within SRS set 1 are to use the PRS group containing PRS resources PRS1, PRS3, or PRS5 as a PRS reference; SRS resources within SRS set 2 are to use the PRS group containing PRS resources PRS2, PRS4, or PRS6 as a PRS reference; and so on. The PRS resources that are members of the pathloss group are typically associated with the same TRP. Thus, PRS resources in one PRS group are at a different physical location from PRS resources in another PRS group and are therefore likely to be a different distance from the UE than PRS resources in another PRS group. In addition, the UE is also provided with information about when each SRS is to be transmitted.

Thus, the UE knows which PRS signals to use as reference signals for particular SRS transmissions, but under current standards, this information is not considered when prioritizing PRS processing. Instead, the UE simply selects the first N PRS resources from the M PRS resources identified by the assistance data.

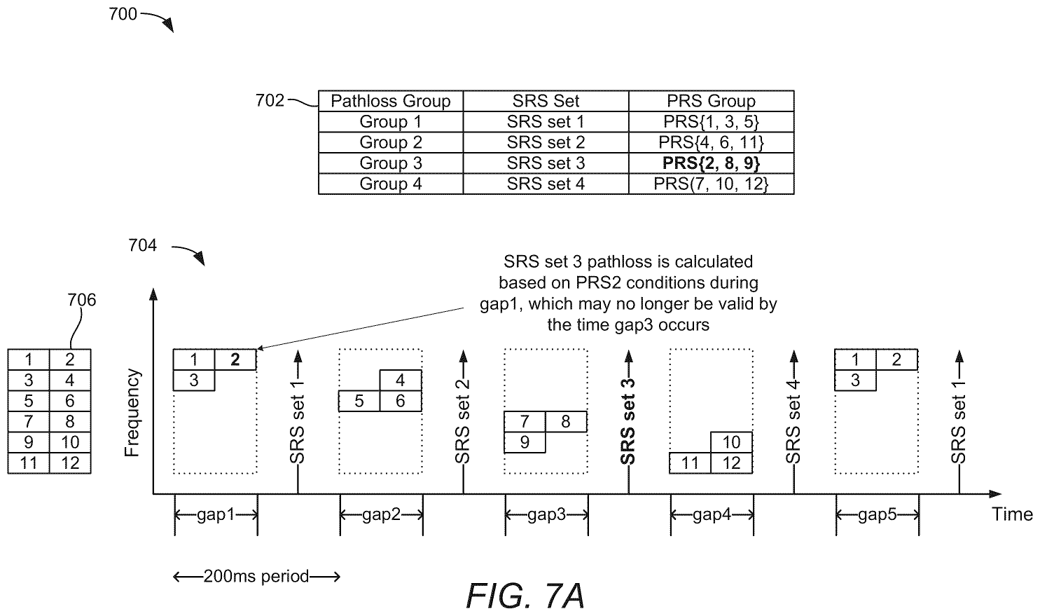

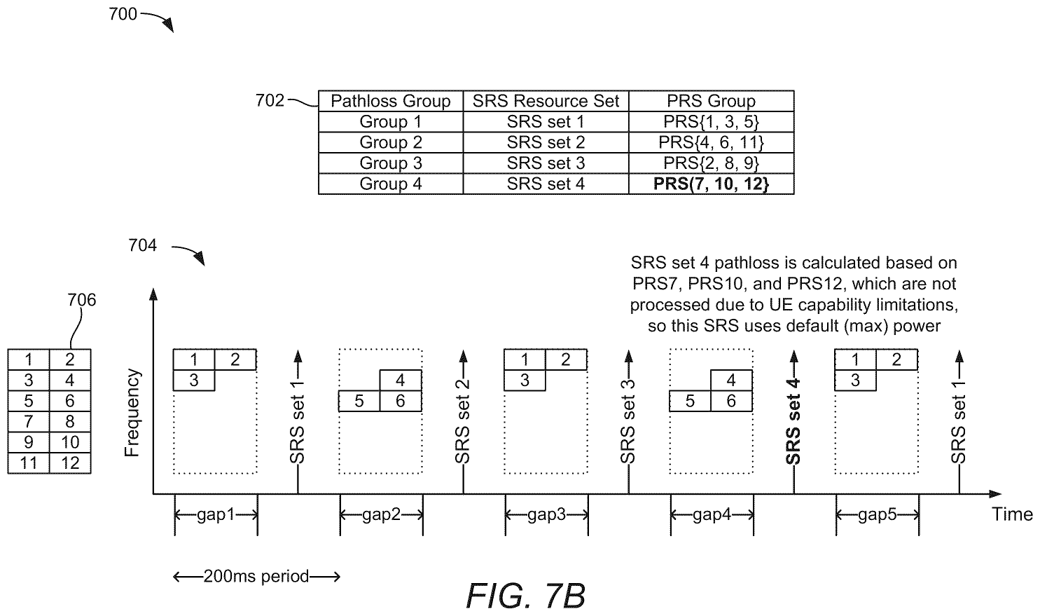

FIGS. 7A and 7B illustrate examples of how this conventional approach 700 can result in sub-optimal prioritization of PRS resources. A UE is provided with information that indicates which PRS signals the UE should use to determine pathloss associated with an SRS, which the UE uses to calculate the transmit power for the SRS. In FIG. 7A and FIG. 7B, a UE has been provided with a pathloss group table 702, which for this example is identical to table 3, above. A time and frequency grid 704 shows measurement gaps gap1 through gap5.

There is a PRS occasion in each gap, and the each PRS occasion contains a set 706 of twelve PRS resources, with locations in the time and frequency grid represented by numbered boxes 1 through 12. In the examples illustrated in FIG. 7A and FIG. 7B, the UE can process only three PRS resources per gap, and the UE processes PRS resources in order according to their index as defined in the assistance data.

Transmission of SRS resources in an SRS set is represented as an upward arrow (rather than as a set of SRS resources in the time/frequency grid), at a location on the time axis showing the SRS transmission time(s) relative to the PRS reception time(s), but it is noted that each SRS set can comprise one or more than one SRS transmission resource.

In FIG. 7A, all of the PRS resources are processed in a round-robin approach. Thus, during the first gap, the UE processes PRS resources 1-3; during the second gap, the UE processes PRS resources 4-6; during the third gap, the UE processes PRS resources 7-9; and during the fourth gap, the UE processes PRS resources 10-12, after which the UE starts over from the top of the list, i.e., during the fifth gap, the UE processes PRS resources 1-3, and so on.

FIG. 7A illustrates one weakness of the conventional method for PRS prioritization, namely, that the PRS reference signals from which SRS transmission power is determined may have occurred so far previously that the channel conditions may no longer be valid. For example, in FIG. 7A, an SRS in SRS set 3, which is transmitted after measurement gap 3, may use as a pathloss or beam reference PRS2, which occurred in measurement gap 1. The channel conditions at the time of measurement gap 1 may have changed significantly by the time of the transmission of SRS signals in SRS set 3. This means that the transmit power used during SRS set 3 may be more than actually needed, which wastes UE power, or less than actually needed, which can lead to a failure to detect or properly decode the SRS by the intended recipient.

FIG. 7B illustrates another weakness of the conventional method for PRS prioritization, namely, that the PRS reference signals from which SRS transmission power is determined may not occur at all. In FIG. 7B, the UE cycles through the PRS resources in a round-robin manner, but only processes the first six PRS resources rather than all of the PRS resources. Thus, in FIG. 7B, the UE processes PRS resources 1-3 in gap 1, PRS resources 4-6 in gap 2, PRS resources 1-3 in gap 3, PRS resources 4-6 in gap 4, and so on. This is a problem for SRS set 4, which uses PRS resources 7, 10, and 12, because the UE never processes PRS resources 7, 10, or 12. In that case, the UE will default to a maximum SRS transmit power, which may consume more battery power than necessary.

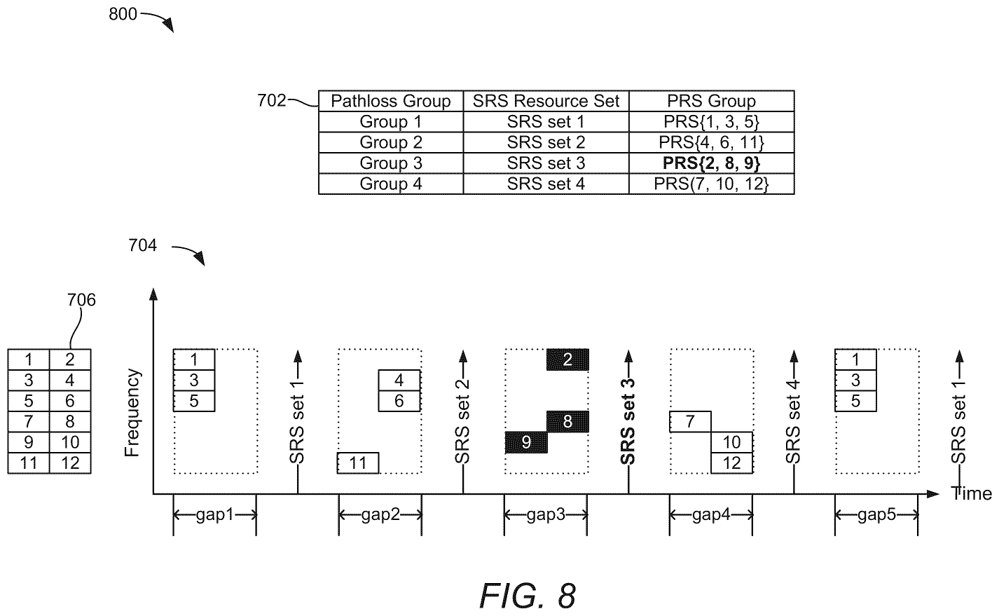

FIG. 8 illustrates a method 800 for prioritization of PRS processing for SRSs for positioning according to some aspects of the disclosure. FIG. 8 illustrates a pathloss group table 702, a time and frequency grid 704, and a set 706 of PRS resources, which are identical to their like-numbered elements in FIGS. 7A and 7B, and whose descriptions will therefore not be repeated here.

In the method 800 illustrated in FIG. 8, rather than prioritization of PRS resources in order by their index in the assistance data, i.e., from highest priority to lowest priority based on PRS measurements, as is conventionally done, the PRS resources are prioritized such that the PRS resources used as a pathloss reference for an SRS are processed in the measuring gap just prior to the SRS transmission occasion. That is, the UE prioritize the processing of the PRS group associated with an SRS set during the measurement gap just prior to that SRS set.

For example, in FIG. 8, SRS set 1 uses PRS resources PRS1, PRS3, and PRS5 as pathloss references, so those three PRS resources are prioritized for processing during gap1, just prior to transmission of SRS signals in SRS set 1. SRS set 2 uses PRS resources PRS4, PRS6, and PRS11 as pathloss references, so those three PRS resources are prioritized for processing during gap2, just prior to transmission of SRS signals in SRS set 2. Likewise, PRS resources PRS2, PRS8, and PRS9 are prioritized for processing during gap 3, just prior to transmission of SRS signals in SRS set 3, and PRS resources PRS7, PRS10, and PRS12 are prioritized for processing during gap 4, just prior to transmission of SRS signals in SRS set 4.

Thus, in contrast to the conventional method shown in FIG. 7A, where PRS2 is processed in gap 1 but SRS set 3 is transmitted after gap 3, in FIG. 8, PRS2 is processed in gap 3, followed by transmission of SRS set 3. Thus, the channel conditions for PRS2 are more likely to still be valid using the method in FIG. 8 compared to the conventional method in FIG. 7A.

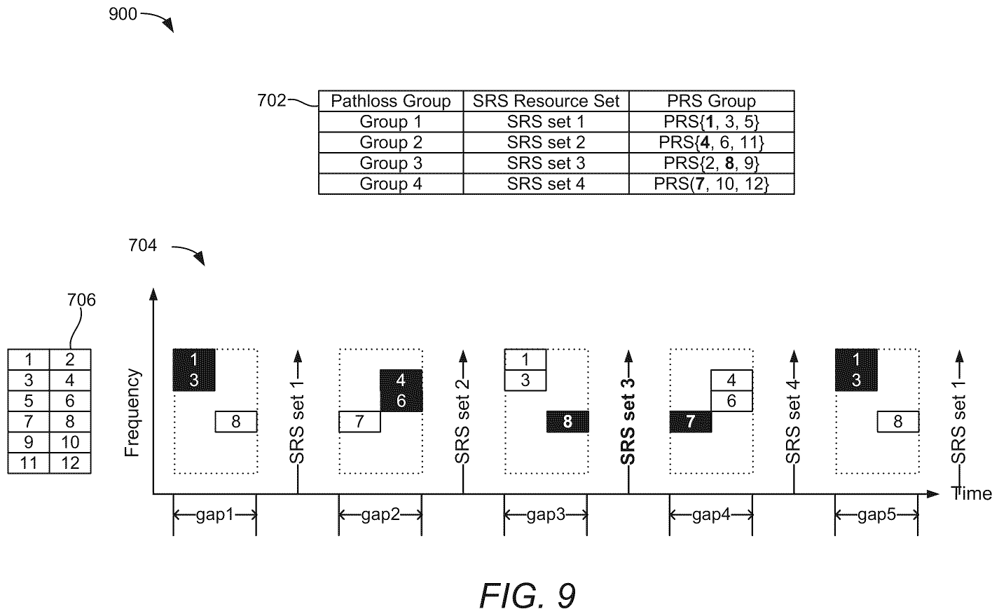

FIG. 9 illustrates a method 900 for prioritization of PRS processing for SRSs for positioning according to some aspects of the disclosure. FIG. 9 illustrates a pathloss group table 702, a time and frequency grid 704, and a set 706 of PRS resources, which are identical to their like-numbered elements in FIGS. 7A and 7B, and whose descriptions will therefore not be repeated here.

In the method 900 illustrated in FIG. 9, rather than prioritization of PRS resources in order by their index in the assistance data, i.e., from highest priority to lowest priority based on PRS measurements, as is conventionally done, the PRS resources are prioritized such that the PRS resources used as a pathloss reference for an SRS are processed in the measuring gap just prior to the SRS transmission occasion, but with the further adjustment that, if not all of the PRS resources can be included in the round-robin cycle, the PRS resources are prioritized to make sure that at least one PRS resource is processed before each SRS set that needs it.

For example, in FIG. 9, SRS set 1 uses PRS resources PRS1, PRS3, and PRS5 as pathloss references, so two of those three PRS resources (e.g., PRS1 and PRS3) are prioritized for processing during gap 1, just prior to transmission of SRS signals in SRS set 1. SRS set 2 uses PRS resources PRS4, PRS6, and PRS11 as pathloss references, so two of those three PRS resources (e.g., PRS4 and PRS6) are prioritized for processing during gap2, just prior to transmission of SRS signals in SRS set 2. Likewise, PRS8 is prioritized for processing during gap 3, just prior to transmission of SRS signals in SRS set 3, which need PRS2, PRS8, or PRS9; and PRS7 is prioritized for processing during gap 4, just prior to transmission of SRS signals in SRS set 4, which need PRS7, PRS10, or PRS12.

Thus, in contrast to the conventional method shown in FIG. 7B, where none of the PRS signals used as pathloss references for SRS set 4 are ever processed, causing SRS set 4 to be transmitted at the default (e.g., maximum) power, in FIG. 9, at least one PRS reference is made available for SRS set 4, so that it does not need to use the default transmit power.

In situations where the UE can process enough PRS resources in each measurement gap such that all of the PRS resources in a pathloss group are processed and the UE has the capability to process even more, then the additional PRS resources to be processed can be selected by various algorithms. In one aspect, the UE selects the additional PRS resources from the pathloss group associated with the SRS transmissions currently having the lowest transmit power, under the assumption that the TRP associated with those PRS resources will be more likely to successfully receive those SRS transmissions. In contrast, the SRS transmissions currently having the highest transmit power are likely to be towards a TRP that is farther away or suffering worse channel conditions, making that TRP less likely to successfully receive those SRS transmissions—so the UE will not prioritize processing of PRS resources associated with that pathloss group.

Moreover, a UE can work on a reduced bandwidth to make pathloss group calculations. For example, using a reduced bandwidth (e.g., BW/4), the UE can find all of the pathloss in the one instance itself, for all of the resource sets. The UE would need to do this group calculation periodically. e.g., every T seconds. In this context, a “group” may correspond to a collection of SRS resources or sets that are transmitted between two PRS instances. For example, a UE may receive the same PRS resource/TRP to be a pathloss reference, a spatial reference, or both, for multiple SRSs. In that case, the UE could reduce the bandwidth of processing the PRS/TRP to find all the pathlosses for the associated SRS resource sets.

FIG. 8 and FIG. 9 illustrate prioritization PRS resources processing based on pathloss groups, but the same principles may be applied to spatial groups, e.g., prioritization of processing of PRS resources based on spatial relation information. In one example, a UE is aware of four TRPs (e.g., TRP1, TRP2, TRP3, and TRP4), each TRP being a physically different distance from the UE and each TRP having four PRS resources. The UE is provided with this information via assistance data. An example of this information in table form is shown below:

TABLE 4

| Spatial Group | SRS Set | UE TRP Resources |
|---|---|---|
| Group 1 | SRS Set 1 | TRP1 (gNB1) |
| Group 2 | SRS Set 2 | TRP2 (gNB2) |
| Group 3 | SRS Set 3 | TRP3 (gNB3) |
| Group 4 | SRS Set 4 | TRP4 (gNB4) |

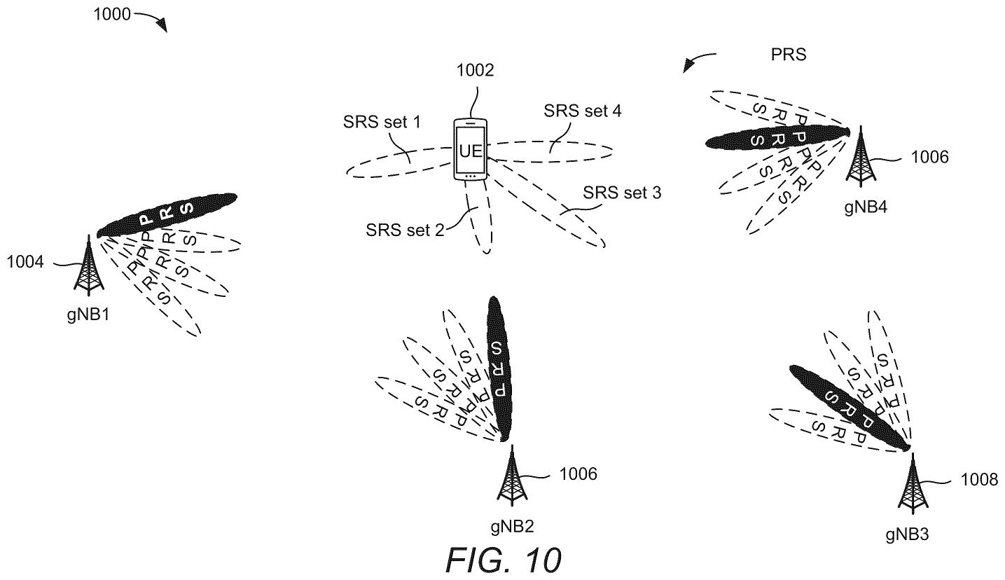

Each SRS set is associated with a spatial group, and thus each SRS set is associated with a beam characteristic (e.g., beam width, beam azimuth and elevation, etc.) Thus, in one aspect, the PRS resource processing can be prioritized to select PRS resources oriented towards the corresponding SRS transmission, as shown in FIG. 10.

FIG. 10 illustrates a method 1000 of prioritization of PRS resources processing based on spatial relations to the SRS signals which use those PRS resources for beam references according to some aspects of the disclosure. In FIG. 10, a UE 1002 receives PRS signals from, and sends SRS signals to, four TRPs, gNB1 1004, gNB2 1006, gNB3 1008, and gNB4 1010. In the example shown in FIG. 10, the UE 1002 transmits SRS signals in SRS set 1 towards gNB1 1004, transmits SRS signals in SRS set 2 towards gNB2 1006, transmits SRS signals in SRS set 3 towards gNB3 1008, and transmits SRS signals in SRS set 4 towards gNB4 1010.

In some aspects, the UE 1002 will prioritize processing of PRS signals from gNB1 in the measurement gap prior to transmission of SRS signals in SRS set 1, prioritize processing of PRS signals from gNB2 in the measurement gap prior to transmission of SRS signals in SRS set 2, and so on. In some aspects, the UE may further consider specific spatial relations information to select, from each TRP, PRS resources that most directly point towards the UE 1002. In FIG. 10, for example, the UE 1002 may prioritize the PRS signals shown as filled ovals over the PRS signals shown as non-filled ovals.

In situations where the UE can process enough PRS resources in each measurement gap such that all of the PRS resources in a spatial group are processed and the UE bas the capability process even more, then the additional PRS resources to be processed can be selected by various algorithms. In one aspect, the UE selects the additional PRS resources from the pathloss group associated with the SRS transmissions having beams more closely matching the current SRS set. In FIG. 10, for example, the PRS resources from gNB2 1006 are prioritized for processing just prior to transmitting SRS signals in SRS set 2; if all of the PRS resources from gNB2 are processed in preparation for transmission of SRS set 2 and the UE 1002 can process a few more, it may choose to process PRS resources from gNB3 1008 rather than from gNB1 1004, since the angle between SRS set 2 and SRS set 3 is less than the angle between SRS set 2 and SRS set 1.

In some aspects, PRS processing may be prioritized based on the consideration of some combination of pathloss and spatial relations information.

FIGS. 8-10 illustrate examples in the Uu setting, i.e., in an interaction between a UE and TRPs that are base stations, in which the UE processes DL-PRS resources and for UL-SRS transmissions, but the same concepts apply to SL communications as well, such as where a relay or helper UE receives a DL-PRS from a base station and transmits a SL-PRS to another UE, and where a UE receives a SL-PRS from, and transmits a SL-PRS to another UE.

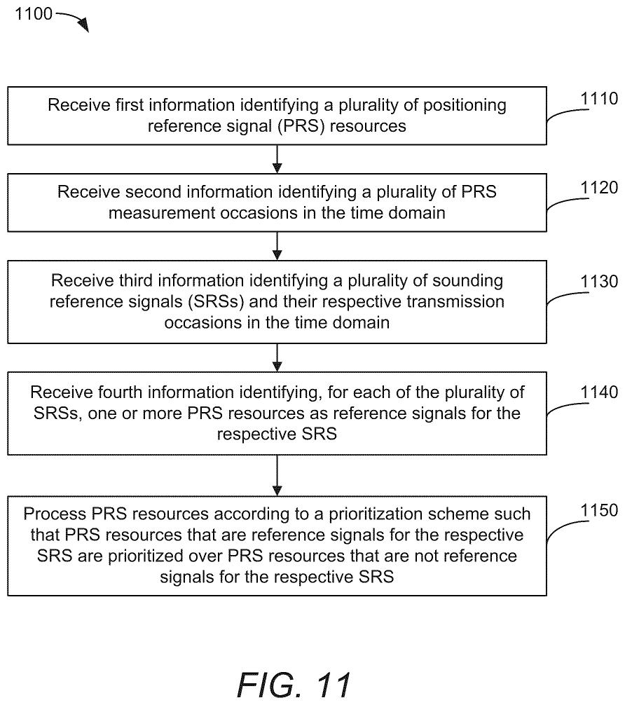

FIG. 11 is a flowchart of an example process 1100 associated with prioritization of PRS processing for SRS for positioning. In some implementations, one or more process blocks of FIG. 11 may be performed by a UE (e.g., UE 104). In some implementations, one or more process blocks of FIG. 11 may be performed by another device or a group of devices separate from or including the UE. Additionally, or alternatively, one or more process blocks of FIG. 11 may be performed by one or more components of UE 302, such as processor(s) 332, memory 340, WWAN transceiver(s) 310, short-range wireless transceiver(s) 320, satellite signal receiver 330, sensor(s) 344, and positioning module(s) 342.

As shown in FIG. 11, process 1100 may include receiving first information identifying a plurality of positioning reference signal (PRS) resources (block 1110). Means for performing the operation of block 1110 may include the WWAN transceiver(s) 310 and memory 340 of UE 302. For example, the UE 302 may receive the first information identifying the PRS resources via receiver(s) 312.

As further shown in FIG. 11, process 1100 may include receiving second information identifying a plurality of PRS measurement occasions in the time domain (block 1120). Means for performing the operation of block 1120 may include the WWAN transceiver(s) 310 and memory 340 of UE 302. For example, the UE 302 may receive the second information identifying the PRS measurement occasions via receiver(s) 312 and store that information in memory 340.

As further shown in FIG. 11, process 1100 may include receiving third information identifying a plurality of sounding reference signals (SRSs) and their respective transmission occasions in the time domain (block 1130). Means for performing the operation of block 1130 may include the WWAN transceiver(s) 310 and memory 340 of UE 302. For example, the UE 302 may receive the third information identifying the SRSs and their respective transmission occasions via receiver(s) 312 and store that information in memory 340.

As further shown in FIG. 11, process 1100 may include receiving fourth information identifying, for each of the plurality of SRSs, one or more PRS resources as reference signals for the respective SRS (block 1140). Means for performing the operation of block 1140 may include the WWAN transceiver(s) 310 and memory 340 of UE 302. For example, the UE 302 may receive the fourth information identifying the one or more PRS resources as reference signals for the respective SRS via receiver(s) 312 and store that information in memory 340. The one or more PRS resources that are reference signals for an SRS may include a PRS resource used as a pathloss reference, a PRS resource used as a spatial relations reference, or a PRS resource used as both a pathloss reference and a spatial relations reference.

As further shown in FIG. 11, process 1100 may include processing PRS resources according to a prioritization scheme such that PRS resources that are reference signals for the respective SRS are prioritized over PRS resources that are not reference signals for the respective SRS (block 1150). Means for performing the operation of block 1150 may include the processor(s) 332 and memory 340 of UE 302. For example, the processor(s) 332 of UE 302 may retrieve the information identifying the PRS resources, the SRSs and their respective transmission occasions, and the PRS resources identified as reference signals for the respective SRSs from memory 340, and prioritize processing of the PRS resources such that for each SRS, PRS resources that are reference signals for the respective SRS are prioritized over PRS resources that are not reference signals for the respective SRS for the PRS measurement occasion prior to and closest in time to the transmission occasion for the respective SRS.

In some aspects, the UE processes a subset less than all of the plurality of PRS resources at each PRS measurement location. In some aspects, the UE processes the same subset of PRS resources at each PRS measurement occasion. In some aspects, at each PRS measurement occasion, the UE processes a different subset of the PRS resources. In some aspects, the UE processes all of the one or more PRS resources over multiple PRS measurement occasions. In some aspects, the UE processes a subset less than all of the one or more PRS resources over multiple PRS measurement occasions. In some aspects, the PRS resources are prioritized such that, for each transmission of an SRS, at least one PRS resource that is a reference signal for that SRS is processed in the PRS measurement occasion prior to and closest in time to the time of transmission of that SRS.

Process 1100 may include additional implementations, such as any single implementation or any combination of implementations described below and/or in connection with one or more other processes described elsewhere herein. Although FIG. 11 shows example blocks of process 1100, in some implementations, process 1100 may include additional blocks, fewer blocks, different blocks, or differently arranged blocks than those depicted in FIG. 11. Additionally, or alternatively, two or more of the blocks of process 1100 may be performed in parallel.

As will be appreciated, technical advantages of the methods of prioritization of PRS processing for SRS for positioning include, but are not limited to, the following. For SRS transmissions whose transmit power is based on measurement of PRS signals that are pathloss and/or spatial relations references for the SRS transmissions, those PRS reference signals may be processed closer in time to the corresponding SRS transmission compared to conventional methods. This reduces the likelihood that the pathloss and/or spatial relation information has become obsolete or inaccurate by time that the SRS transmission occurs, and may improve the quality of Rx-Tx measurements on both the UE and the gNB sides. By guaranteeing that at least some PRS resources are processed for each SRS resource group, the likelihood that an SRS must be transmitted using a default maximum transmission power is also reduced, which saves UE battery power.

In the detailed description above it can be seen that different features are grouped together in examples. This manner of disclosure should not be understood as an intention that the example clauses have more features than are explicitly mentioned in each clause. Rather, the various aspects of the disclosure may include fewer than all features of an individual example clause disclosed. Therefore, the following clauses should hereby be deemed to be incorporated in the description, wherein each clause by itself can stand as a separate example. Although each dependent clause can refer in the clauses to a specific combination with one of the other clauses, the aspect(s) of that dependent clause are not limited to the specific combination. It will be appreciated that other example clauses can also include a combination of the dependent clause aspect(s) with the subject matter of any other dependent clause or independent clause or a combination of any feature with other dependent and independent clauses. The various aspects disclosed herein expressly include these combinations, unless it is explicitly expressed or can be readily inferred that a specific combination is not intended (e.g., contradictory aspects, such as defining an element as both an insulator and a conductor). Furthermore, it is also intended that aspects of a clause can be included in any other independent clause, even if the clause is not directly dependent on the independent clause.

Implementation examples are described in the following numbered clauses:
Clause 1. A method of wireless communication performed by a user equipment (UE), the method comprising: receiving first information identifying a plurality of positioning reference signal (PRS) resources: receiving second information identifying a plurality of PRS measurement occasions in a time domain; receiving third information identifying a plurality of sounding reference signals (SRSs) and their respective transmission occasions in the time domain: receiving fourth information identifying, for each of the plurality of SRSs, one or more PRS resources as reference signals for the respective SRS; and processing PRS resources according to a prioritization scheme such that PRS resources that are reference signals for the respective SRS are prioritized over PRS resources that are not reference signals for the respective SRS.
Clause 2. The method of clause 1, wherein processing PRS resources according to the prioritization scheme comprises processing of PRS resources such that, in a PRS measurement occasion prior to and closest in time to transmission of an SRS, PRS resources that are reference signals for the respective SRS are prioritized over PRS resources that are not reference signals for the respective SRS.
Clause 3. The method of any of clauses 1 to 2, wherein the one or more PRS resources as reference signals for the respective SRS comprise a PRS resource used as a pathloss reference, a PRS resource used as a spatial relations reference, or a PRS resource used as both a pathloss reference and a spatial relations reference.
Clause 4. The method of any of clauses 1 to 3, wherein, at each PRS measurement occasion, the UE processes a subset less than all of the plurality of PRS resources.
Clause 5. The method of clause 4, wherein the UE processes a same subset of PRS resources at each PRS measurement occasion.
Clause 6. The method of any of clauses 4 to 5, wherein the UE processes a different subset of the PRS resources at each PRS measurement occasion.
Clause 7. The method of clause 6, wherein the UE processes all of the one or more PRS resources over multiple PRS measurement occasions.
Clause 8. The method of any of clauses 6 to 7, wherein the UE processes a subset less than all of the one or more PRS resources over multiple PRS measurement occasions.
Clause 9. The method of clause 8, wherein processing PRS resources according to the prioritization scheme comprises processing of PRS resources such that, for each transmission of an SRS, at least one PRS resource that is the reference signal for the respective SRS is processed in a PRS measurement occasion prior to and closest in time to a time of transmission of the respective SRS
Clause 10. A user equipment (UE), comprising: a memory; at least one transceiver; and at least one processor communicatively coupled to the memory and the at least one transceiver, the at least one processor configured to: receive, via the at least one transceiver, first information identifying a plurality of positioning reference signal (PRS) resources; receive, via the at least one transceiver, second information identifying a plurality of PRS measurement occasions in a time domain; receive, via the at least one transceiver, third information identifying a plurality of sounding reference signals (SRSs) and their respective transmission occasions in the time domain; receive, via the at least one transceiver, fourth information identifying, for each of the plurality of SRSs, one or more PRS resources as reference signals for the respective SRS; and process PRS resources according to a prioritization scheme such that PRS resources that are reference signals for the respective SRS are prioritized over PRS resources that are not reference signals for the respective SRS.
Clause 11. The UE of clause 10, wherein, to process PRS resources according to the prioritization scheme, the at least one processor is configured to process the PRS resources such that, in a PRS measurement occasion prior to and closest in time to transmission of an SRS. PRS resources that are reference signals for the respective SRS are prioritized over PRS resources that are not reference signals for the respective SRS.
Clause 12. The UE of any of clauses 10 to 11, wherein the fourth information identifying one or more PRS resources as reference signals for the respective SRS comprises information identifying a PRS resource used as a pathloss reference, a PRS resource used as a spatial relations reference, or a PRS resource used as both a pathloss reference and a spatial relations reference.
Clause 13. The UE of any of clauses 10 to 12, wherein, at each PRS measurement occasion, the UE processes a subset less than all of the plurality of PRS resources.
Clause 14. The UE of clause 13, wherein the at least one processor is configured to process a same subset of PRS resources at each PRS measurement occasion.
Clause 15. The UE of any of clauses 13 to 14, wherein the at least one processor is configured to process a different subset of the PRS resources at each PRS measurement occasion.
Clause 16. The UE of clause 15, wherein the at least one processor is configured to process all of the one or more PRS resources over multiple PRS measurement occasions.
Clause 17. The UE of any of clauses 15 to 16, wherein the at least one processor is configured to process a subset less than all of the one or more PRS resources over multiple PRS measurement occasions.
Clause 18. The UE of clause 17, wherein, to process PRS resources according to the prioritization scheme, the at least one processor is configured to process the PRS resources such that, for each transmission of an SRS, at least one PRS resource that is the reference signal for the respective SRS is processed in a PRS measurement occasion prior to and closest in time to a time of transmission of the respective SRS.
Clause 19. A user equipment (UE), comprising: means for receiving first information identifying a plurality of positioning reference signal (PRS) resources; means for receiving second information identifying a plurality of PRS measurement occasions in a time domain; means for receiving third information identifying a plurality of sounding reference signals (SRSs) and their respective transmission occasions in the time domain; means for receiving fourth information identifying, for each of the plurality of SRSs, one or more PRS resources as reference signals for the respective SRS; and means for processing PRS resources according to a prioritization scheme such that PRS resources that are reference signals for the respective SRS are prioritized over PRS resources that are not reference signals for the respective SRS.
Clause 20. The UE of clause 19, wherein the means for processing PRS resources according to the prioritization scheme comprises means for processing of PRS resources such that, in a PRS measurement occasion prior to and closest in time to transmission of an SRS, PRS resources that are reference signals for the respective SRS are prioritized over PRS resources that are not reference signals for the respective SRS.
Clause 21. The UE of any of clauses 19 to 20, wherein the one or more PRS resources as reference signals for the respective SRS comprise a PRS resource used as a pathloss reference, a PRS resource used as a spatial relations reference, or a PRS resource used as both a pathloss reference and a spatial relations reference.
Clause 22. The UE of any of clauses 19 to 21, wherein the means for processing PRS resources according to the prioritization scheme comprises means for processing of PRS resources such that the UE processes a subset less than all of the plurality of PRS resources at each PRS measurement occasion.
Clause 23. The UE of clause 22, wherein the means for processing PRS resources according to the prioritization scheme comprises means for processing of PRS resources such that the UE processes a same subset of PRS resources at each PRS measurement occasion.
Clause 24. The UE of any of clauses 22 to 23, wherein the means for processing PRS resources according to the prioritization scheme comprises means for processing of PRS resources such that the UE processes a different subset of the PRS resources at each PRS measurement occasion.
Clause 25. The UE of clause 24, wherein the means for processing PRS resources according to the prioritization scheme comprises means for processing of PRS resources such that the UE processes all of the one or more PRS resources over multiple PRS measurement occasions.
Clause 26. The UE of any of clauses 24 to 25, wherein the means for processing PRS resources according to the prioritization scheme comprises means for processing of PRS resources such that the UE processes a subset less than all of the one or more PRS resources over multiple PRS measurement occasions.
Clause 27. The UE of clause 26, wherein the means for processing PRS resources according to the prioritization scheme comprises means for processing of PRS resources such that, for each transmission of an SRS, at least one PRS resource that is the reference signal for the respective SRS is processed in a PRS measurement occasion prior to and closest in time to a time of transmission of the respective SRS.
Clause 28. A non-transitory computer-readable medium storing computer-executable instructions that, when executed by a user equipment (UE), cause the UE to: receive first information identifying a plurality of positioning reference signal (PRS) resources; receive second information identifying a plurality of PRS measurement occasions in a time domain; receive third information identifying a plurality of sounding reference signals (SRSs) and their respective transmission occasions in the time domain; receive fourth information identifying, for each of the plurality of SRSs, one or more PRS resources as reference signals for the respective SRS; and process PRS resources according to a prioritization scheme such that PRS resources that are reference signals for the respective SRS are prioritized over PRS resources that are not reference signals for the respective SRS.
Clause 29. The non-transitory computer-readable medium of clause 28, wherein the computer-executable instructions that cause the UE to process PRS resources according to the prioritization scheme comprise computer-executable instructions that cause the UE to processing of PRS resources such that, in a PRS measurement occasion prior to and closest in time to transmission of an SRS, PRS resources that are reference signals for the respective SRS are prioritized over PRS resources that are not reference signals for the respective SRS.
Clause 30. The non-transitory computer-readable medium of any of clauses 28 to 29, wherein the one or more PRS resources as reference signals for the respective SRS comprise a PRS resource used as a pathloss reference, a PRS resource used as a spatial relations reference, or a PRS resource used as both a pathloss reference and a spatial relations reference.
Clause 31. The non-transitory computer-readable medium of any of clauses 28 to 30, wherein, at each PRS measurement occasion, the UE processes a subset less than all of the plurality of PRS resources.
Clause 32. The non-transitory computer-readable medium of clause 31, wherein the UE processes a same subset of PRS resources at each PRS measurement occasion.
Clause 33. The non-transitory computer-readable medium of any of clauses 31 to 32, wherein, at each PRS measurement occasion, the UE processes a different subset of the PRS resources.
Clause 34. The non-transitory computer-readable medium of clause 33, wherein the UE processes all of the one or more PRS resources over multiple PRS measurement occasions.
Clause 35. The non-transitory computer-readable medium of any of clauses 33 to 34, wherein the UE processes a subset less than all of the one or more PRS resources over multiple PRS measurement occasions.
Clause 36. The non-transitory computer-readable medium of clause 35, wherein the computer-executable instructions that cause the UE to process PRS resources according to the prioritization scheme comprise computer-executable instructions that cause the UE to processing of PRS resources such that, for each transmission of an SRS, at least one PRS resource that is the reference signal for the respective SRS is processed in a PRS measurement occasion prior to and closest in time to a time of transmission of the respective SRS.
Clause 37. An apparatus comprising a memory, a transceiver, and a processor communicatively coupled to the memory and the transceiver, the memory, the transceiver, and the processor configured to perform a method according to any of clauses 1 to 9.
Clause 38. An apparatus comprising means for performing a method according to any of clauses 1 to 9.
Clause 39. A non-transitory computer-readable medium storing computer-executable instructions, the computer-executable comprising at least one instruction for causing a computer or processor to perform a method according to any of clauses 1 to 9.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a general-purpose processor, a digital signal processor (DSP), an ASIC, a field-programable gate array (FPGA), or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, for example, a combination of a DSP and a microprocessor, a plurality of microprocessors, one or more microprocessors in conjunction with a DSP core, or any other such configuration.

The methods, sequences and/or algorithms described in connection with the aspects disclosed herein may be embodied directly in hardware, in a software module executed by a processor, or in a combination of the two. A software module may reside in random access memory (RAM), flash memory, read-only memory (ROM), erasable programmable ROM (EPROM), electrically erasable programmable ROM (EEPROM), registers, hard disk, a removable disk, a CD-ROM, or any other form of storage medium known in the art. An example storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., UE). In the alternative, the processor and the storage medium may reside as discrete components in a user terminal.

In one or more example aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

While the foregoing disclosure shows illustrative aspects of the disclosure, it should be noted that various changes and modifications could be made herein without departing from the scope of the disclosure as defined by the appended claims. The functions, steps and/or actions of the method claims in accordance with the aspects of the disclosure described herein need not be performed in any particular order. Furthermore, although elements of the disclosure may be described or claimed in the singular, the plural is contemplated unless limitation to the singular is explicitly stated.

What is claimed is:

1. A method of wireless communication performed by a user equipment (UE), the method comprising:
receiving first information identifying a plurality of positioning reference signal (PRS) resources;
receiving second information identifying a plurality of PRS measurement occasions in a time domain;
receiving third information identifying a plurality of sounding reference signals (SRSs) and their respective transmission occasions in the time domain;
receiving fourth information identifying, for each of the plurality of SRSs, one or more PRS resources as reference signals for the respective SRS; and
processing PRS resources according to a prioritization scheme such that PRS resources that are reference signals for the respective SRS are prioritized over PRS resources that are not reference signals for the respective SRS.

2. The method of claim 1, wherein processing PRS resources according to the prioritization scheme comprises processing of PRS resources such that, in a PRS measurement occasion prior to and closest in time to transmission of an SRS, PRS resources that are reference signals for the respective SRS are prioritized over PRS resources that are not reference signals for the respective SRS.

3. The method of claim 1, wherein the one or more PRS resources as reference signals for the respective SRS comprise a PRS resource used as a pathloss reference, a PRS resource used as a spatial relations reference, or a PRS resource used as both a pathloss reference and a spatial relations reference.

4. The method of claim 1, wherein, at each PRS measurement occasion, the UE processes a subset less than all of the plurality of PRS resources.

5. The method of claim 4, wherein the UE processes a same subset of PRS resources at each PRS measurement occasion.

6. The method of claim 4, wherein the UE processes a different subset of the PRS resources at each PRS measurement occasion.

7. The method of claim 6, wherein the UE processes all of the one or more PRS resources over multiple PRS measurement occasions.

8. The method of claim 6, wherein the UE processes a subset less than all of the one or more PRS resources over multiple PRS measurement occasions.

9. The method of claim 8, wherein processing PRS resources according to the prioritization scheme comprises processing of PRS resources such that, for each transmission of an SRS, at least one PRS resource that is the reference signal for the respective SRS is processed in a PRS measurement occasion prior to and closest in time to a time of transmission of the respective SRS.

10. A user equipment (UE), comprising:
a memory;
at least one transceiver; and
at least one processor communicatively coupled to the memory and the at least one transceiver, the at least one processor configured to:
receive, via the at least one transceiver, first information identifying a plurality of positioning reference signal (PRS) resources;
receive, via the at least one transceiver, second information identifying a plurality of PRS measurement occasions in a time domain;
receive, via the at least one transceiver, third information identifying a plurality of sounding reference signals (SRSs) and their respective transmission occasions in the time domain;
receive, via the at least one transceiver, fourth information identifying, for each of the plurality of SRSs, one or more PRS resources as reference signals for the respective SRS; and
process PRS resources according to a prioritization scheme such that PRS resources that are reference signals for the respective SRS are prioritized over PRS resources that are not reference signals for the respective SRS.

11. The UE of claim 10, wherein, to process PRS resources according to the prioritization scheme, the at least one processor is configured to process the PRS resources such that, in a PRS measurement occasion prior to and closest in time to transmission of an SRS, PRS resources that are reference signals for the respective SRS are prioritized over PRS resources that are not reference signals for the respective SRS.

12. The UE of claim 10, wherein the fourth information identifying one or more PRS resources as reference signals for the respective SRS comprises information identifying a PRS resource used as a pathloss reference, a PRS resource used as a spatial relations reference, or a PRS resource used as both a pathloss reference and a spatial relations reference.

13. The UE of claim 10, wherein, at each PRS measurement occasion, the UE processes a subset less than all of the plurality of PRS resources.

14. The UE of claim 13, wherein the at least one processor is configured to process a same subset of PRS resources at each PRS measurement occasion.

15. The UE of claim 13, wherein the at least one processor is configured to process a different subset of the PRS resources at each PRS measurement occasion.

16. The UE of claim 15, wherein the at least one processor is configured to process all of the one or more PRS resources over multiple PRS measurement occasions.

17. The UE of claim 15, wherein the at least one processor is configured to process a subset less than all of the one or more PRS resources over multiple PRS measurement occasions.

18. The UE of claim 17, wherein, to process PRS resources according to the prioritization scheme, the at least one processor is configured to process the PRS resources such that, for each transmission of an SRS, at least one PRS resource that is the reference signal for the respective SRS is processed in a PRS measurement occasion prior to and closest in time to a time of transmission of the respective SRS.

19. A user equipment (UE), comprising:
means for receiving first information identifying a plurality of positioning reference signal (PRS) resources;
means for receiving second information identifying a plurality of PRS measurement occasions in a time domain;
means for receiving third information identifying a plurality of sounding reference signals (SRSs) and their respective transmission occasions in the time domain;
means for receiving fourth information identifying, for each of the plurality of SRSs, one or more PRS resources as reference signals for the respective SRS; and
means for processing PRS resources according to a prioritization scheme such that PRS resources that are reference signals for the respective SRS are prioritized over PRS resources that are not reference signals for the respective SRS.

20. The UE of claim 19, wherein the means for processing PRS resources according to the prioritization scheme comprises means for processing of PRS resources such that, in a PRS measurement occasion prior to and closest in time to transmission of an SRS, PRS resources that are reference signals for the respective SRS are prioritized over PRS resources that are not reference signals for the respective SRS.

21. The UE of claim 19, wherein the one or more PRS resources as reference signals for the respective SRS comprise a PRS resource used as a pathloss reference, a PRS resource used as a spatial relations reference, or a PRS resource used as both a pathloss reference and a spatial relations reference.

22. The UE of claim 19, wherein the means for processing PRS resources according to the prioritization scheme comprises means for processing of PRS resources such that the UE processes a subset less than all of the plurality of PRS resources at each PRS measurement occasion.

23. The UE of claim 22, wherein the means for processing PRS resources according to the prioritization scheme comprises means for processing of PRS resources such that the UE processes a same subset of PRS resources at each PRS measurement occasion.

24. The UE of claim 22, wherein the means for processing PRS resources according to the prioritization scheme comprises means for processing of PRS resources such that the UE processes a different subset of the PRS resources at each PRS measurement occasion.

25. The UE of claim 24, wherein the means for processing PRS resources according to the prioritization scheme comprises means for processing of PRS resources such that the UE processes all of the one or more PRS resources over multiple PRS measurement occasions.

26. The UE of claim 24, wherein the means for processing PRS resources according to the prioritization scheme comprises means for processing of PRS resources such that the UE processes a subset less than all of the one or more PRS resources over multiple PRS measurement occasions.

27. The UE of claim 26, wherein the means for processing PRS resources according to the prioritization scheme comprises means for processing of PRS resources such that, for each transmission of an SRS, at least one PRS resource that is the reference signal for the respective SRS is processed in a PRS measurement occasion prior to and closest in time to a time of transmission of the respective SRS.

28. A non-transitory computer-readable medium storing computer-executable instructions that, when executed by a user equipment (UE), cause the UE to:
receive first information identifying a plurality of positioning reference signal (PRS) resources;
receive second information identifying a plurality of PRS measurement occasions in a time domain;
receive third information identifying a plurality of sounding reference signals (SRSs) and their respective transmission occasions in the time domain;
receive fourth information identifying, for each of the plurality of SRSs, one or more PRS resources as reference signals for the respective SRS; and
process PRS resources according to a prioritization scheme such that PRS resources that are reference signals for the respective SRS are prioritized over PRS resources that are not reference signals for the respective SRS.

29. The non-transitory computer-readable medium of claim 28, wherein the computer-executable instructions that cause the UE to process PRS resources according to the prioritization scheme comprise computer-executable instructions that cause the UE to processing of PRS resources such that, in a PRS measurement occasion prior to and closest in time to transmission of an SRS, PRS resources that are reference signals for the respective SRS are prioritized over PRS resources that are not reference signals for the respective SRS.

30. The non-transitory computer-readable medium of claim 28, wherein the one or more PRS resources as reference signals for the respective SRS comprise a PRS resource used as a pathloss reference, a PRS resource used as a spatial relations reference, or a PRS resource used as both a pathloss reference and a spatial relations reference.

31. The non-transitory computer-readable medium of claim 28, wherein, at each PRS measurement occasion, the UE processes a subset less than all of the plurality of PRS resources.

32. The non-transitory computer-readable medium of claim 31, wherein the UE processes a same subset of PRS resources at each PRS measurement occasion.

33. The non-transitory computer-readable medium of claim 31, wherein, at each PRS measurement occasion, the UE processes a different subset of the PRS resources.

34. The non-transitory computer-readable medium of claim 33, wherein the UE processes all of the one or more PRS resources over multiple PRS measurement occasions.

35. The non-transitory computer-readable medium of claim 33, wherein the UE processes a subset less than all of the one or more PRS resources over multiple PRS measurement occasions.

36. The non-transitory computer-readable medium of claim 35, wherein the computer-executable instructions that cause the UE to process PRS resources according to the prioritization scheme comprise computer-executable instructions that cause the UE to processing of PRS resources such that, for each transmission of an SRS, at least one PRS resource that is the reference signal for the respective SRS is processed in a PRS measurement occasion prior to and closest in time to a time of transmission of the respective SRS.
